(19) United States
(12) Patent Application Publication
(10) Pub. No.: US 2026/0303871 A1
(43) Pub. Date: Oct. 1, 2026

(54) SYNTAX FOR IMAGE/VIDEO COMPRESSION WITH GENERIC CODEBOOK-BASED REPRESENTATION

(71) Applicant: InterDigital VC Holdings, Inc., Wilmington, DE (US)

(72) Inventors: Fabien RACAPE, SAN FRANCISCO, CA (US); Hyomin CHOI, SUNNYVALE, CA (US); Fatih KAMISLI, CANKAYA, ANKARA (TR); Wei JIANG, SUNNYVALE, CA (US)

(21) Appl. No.: 19/478,182

(22) PCT Filed: Apr. 26, 2024
(86) PCT No.: PCT/US2024/026438

§ 371 Date: Oct. 23, 2025

Related U.S. Application Data
(60) Provisional application No. 63/462,591, filed on Apr. 28, 2023.

(51) Int. Cl. H04N 19/70; H04N 19/136; H04N 19/167

(52) U.S. Cl. CPC H04N 19/70; H04N 19/136; H04N 19/167

(57) ABSTRACT

At least one method and apparatus are presented for efficiently encoding or decoding video, for example human-centric video content. For example, at least one embodiment receiving a bitstream comprising a low-quality representation of at least one region of a sequence of images along with metadata specifying at least one generic codebook-based representation of a generic feature of at least one region of the sequence of images, wherein the at least one generic codebook-based representation allows determining, by a generative branch, a generic feature adapted to a plurality of computer vision tasks; and decoding, from the bitstream, a reconstructed image adapted to a plurality of computer vision tasks including both machine consumption and human consumption. Advantageously, such representation with associated metadata provides, for content such as human-centric video, a generative video coding framework that can be flexibly configured to accommodate both human and machine consumption.

### CROSS REFERENCE TO RELATED APPLICATIONS

This application claims the benefit of U.S. Patent Application No. 63/462,591, filed on Apr. 28, 2023, which is incorporated herein by reference in its entirety.

### TECHNICAL FIELD

At least one of the present embodiments generally relates to a method or an apparatus for video encoding or decoding in the context of human-centric video content, for both tasks aiming at human consumption like video conferencing and/or tasks aiming at machine consumption like face recognition. More particularly, at least one of the present embodiments relates to a method or an apparatus for decoding a video using metadata specifying at least one generic codebook-based representation of a generic feature of at least one region of the sequence of images.

### BACKGROUND

It is essentially important to effectively compress and transmit human-centric videos for a variety of applications, such as video conferencing, video surveillance, etc. By and large, standard video codecs such as AVC, HEVC and VVC have been developed for compressing natural image/video data. In recent years, end-to-end Learned Image Coding (LIC) or video coding based on Neural Networks (NN) have also been developed. Currently MPEG is exploring these technologies. The video coding tools in prior video codecs are designed to improve coding efficiency for general image and video content, some specially designed for screen contents. They are not optimized for the human-centric videos. In most cases, human faces are the primary content of such videos. For example, the primary people talking at the center of the video frame are the focus of video conferencing videos, or the detected faces are the main focus of many surveillance videos. Since facial attributes are widely shared between people from the structural perspective, such characteristics can be efficiently coded with common representations that cost much less bits to transfer than compressing original pixels with off-the-shelf codecs. This enables a coding framework to compress the face with extremely low bitrate and to reconstruct the face with decent quality.

Depending on different applications, the requirements of video compression vary in practice. For example, in tasks mainly for human consumption such as video conferencing, faces need to be restored with high-perceptual-quality so that the decoded video looks realistic and pleasant to human eyes. In tasks mainly for machine consumption such as face recognition in surveillance domain, identity-preserving cues need to be restored so that decoded videos can maintain the recognition accuracy for further analysis by machine. Previous methods, in general, treat different applications separately, where a video coding framework is customized for either human consumption or machine consumption. So far, no existing method can provide a generic video coding framework that can be flexibly configured to accommodate both human and machine consumption.

### SUMMARY

The U.S. patent application 63/447,697 filed on Feb. 23, 2023, by the same applicant describes a framework for encoding/decoding a video using a scalable latent representation comprising a generic codebook-based representation and a low-quality latent representation of the video. Advantageously, such scalable latent representation provides, for content such as human-centric video, an adaptive video coding framework that can be flexibly configured to accommodate both human and machine consumption tasks. At least one embodiment of the present principles allows to convey the required indices and combining weights information to enable the decoder to reconstruct human faces based on the codebook-based branches described in the U.S. patent application 63/447,697 when combined with video compression standards.

To that end, at least one embodiment discloses receiving a bitstream comprising a low-quality representation of at least one region of a sequence of images along with metadata specifying at least one generic codebook-based representation of a generic feature of at least one region of the sequence of images, wherein the at least one generic codebook-based representation allows to determining, by a generative branch, a generic feature adapted to a plurality of computer vision tasks; and decoding, from the bitstream, a reconstructed image adapted to a plurality of computer vision tasks including both machine consumption and human consumption.

According to a first embodiment, the low-quality representation of at least one region of a sequence of images comprises coded data including the at least one region and a background of the at least one region of the sequence of images, wherein data are coded using a traditional video compression standard.

According to a second embodiment, the low-quality representation of at least one region of a sequence of images and a background of the at least one region of the sequence of images are coded separately and form 2 parts of the bitstream. According to a first variant of the second embodiment, the low-quality representation of at least one region of a sequence of images comprises coded data using a video compression standard and the bitstream further comprises coded data representative of a background of at least one region of the sequence of images using a video compression standard. According to a second variant of the second embodiment, the low-quality representation of at least one region of a sequence of images comprises coded data using a normative generative compression standard and the bitstream further comprises coded data representative of a background of at least one region of the sequence of images using a video compression standard. In that case, the low-quality representation is a latent representation where the at least one region of a sequence of images is LIC based method as described in the embodiments U.S. patent application 63/447,697.

According to another aspect, at least one embodiment discloses obtaining a sequence of images to encode; obtaining a sequence of images to encode; generating a low-quality representation of at least one region of a sequence of images along with metadata specifying at least one generic codebook-based representation of a generic feature of at least one region of the sequence of images, wherein the at least one generic codebook-based representation allows determining, by a generative branch, a generic feature adapted to a plurality of computer vision tasks; and encoding, in a bitstream, the low-quality representation of at least one region of a sequence of images along with metadata specifying at least one generic codebook-based representation of a generic feature of at least one region of the sequence of images. According to a particular embodiment, at least one generic codebook-based representation of a generic feature of at least one region of the sequence of images is obtained by mapping a generic feature of at least one region of the sequence of images to a generic codebook, wherein, in a generative branch, a neural network-based generic embedding feature processing is applied to the sequence of images to generate the generic feature.

One or more embodiments also provide a computer program comprising instructions which when executed by one or more processors cause the one or more processors to perform the encoding method or decoding method according to any of the embodiments described herein. One or more of the present embodiments also provide a computer readable storage medium having stored thereon instructions for video encoding or decoding according to the methods described herein.

One or more embodiments also provide a computer readable storage medium having stored thereon video data generated according to the methods described above. One or more embodiments also provide a method and apparatus for transmitting or receiving the video data generated according to the methods described herein.

### BRIEF DESCRIPTION OF THE DRAWINGS

FIG. 1 illustrates a block diagram of a system within which aspects of the present embodiments may be implemented.

FIG. 2 illustrates a block diagram of a generic embodiment of traditional video encoder.

FIG. 3 illustrates a block diagram of a generic embodiment of traditional video encoder.

FIG. 4 illustrates a general workflow of AI-based human-centric video compression system according to an embodiment.

FIG. 5 illustrates a workflow of a novel human-centric video coding solution according to an embodiment.

FIG. 6 illustrates a workflow of a novel human-centric video coding solution according to another embodiment.

FIG. 7 illustrates a workflow of the reconstruction module according to an embodiment.

FIG. 8 illustrates a decoding method according to a generic embodiment.

FIG. 9 illustrates an encoding method according to a generic embodiment.

FIG. 10 shows two examples of an original and reconstructed image according to at least one embodiment.

FIG. 11 shows an example of application to which aspects of the present embodiments may be applied.

FIG. 12 shows two remote devices communicating over a communication network in accordance with an example of present principles in which various aspects of the embodiments may be implemented.

FIG. 13 shows the syntax of a signal in accordance with an example of present principles.

### DETAILED DESCRIPTION

Various embodiments relate to a video coding system in which, in at least one embodiment, it is proposed to adapt video encoding/decoding tools to hybrid machine/human vision applications. Different embodiments are proposed hereafter, introducing some tools modifications to increase coding efficiency and improve the codec consistency when both applications are targeted. Amongst others, a decoding method, an encoding method, a decoding apparatus and an encoding apparatus implementing a representation of a video providing a domain-adaptive and a task-adaptive video bitstream that can be flexibly configured to accommodate both human and machine consumption at the decoder are proposed.

The present aspects are described in the context of ISO/MPEG Working Group 4, called Video Coding for Machine (VCM) and of JPEG-AI. The Video Coding for Machines (VCM) is an MPEG activity aiming to standardize a bitstream format generated by compressing either a video stream or previously extracted features. The bitstream should enable multiple machine vision tasks by embedding the necessary information for performing multiple tasks at the receiver, such as segmentation, object tracking, face recognition, video conferencing, as well as reconstruction of the video contents for human consumption. In parallel, JPEG is standardizing JPEG-AI which is projected to involve end-to-end NN-based image compression method that is also capable to be optimized for some machine analytics tasks. One can easily envision other similar flavor of standards and forthcoming systems in the near future for VCM paradigm as use cases are already ubiquitous such as video surveillance, autonomous vehicles, smart cities etc.

The present aspects are not limited to those standardization works and can be applied, for example, to other standards and recommendations, whether pre-existing or future-developed, and extensions of any such standards and recommendations. Unless indicated otherwise, or technically precluded, the aspects described in this application can be used individually or in combination.

The acronyms used herein are reflecting the current state of video coding developments and thus should be considered as examples of naming that may be renamed at later stages while still representing the same techniques.

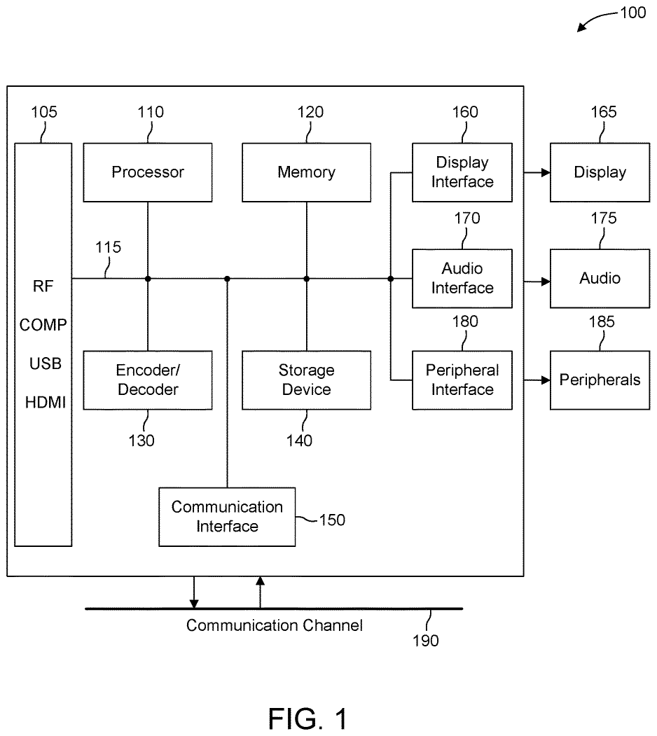

FIG. 1 illustrates a block diagram of an example of a system in which various aspects and embodiments can be implemented. System 100 may be embodied as a device including the various components described below and is configured to perform one or more of the aspects described in this application. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 100, singly or in combination, may be embodied in a single integrated circuit, multiple ICs, and/or discrete components. For example, in at least one embodiment, the processing and encoder/decoder elements of system 100 are distributed across multiple ICs and/or discrete components. In various embodiments, the system 100 is communicatively coupled to other systems, or to other electronic devices, via, for example, a communications bus or through dedicated input and/or output ports. In various embodiments, the system 100 is configured to implement one or more of the aspects described in this application.

The system 100 includes at least one processor 110 configured to execute instructions loaded therein for implementing, for example, the various aspects described in this application. Processor 110 may include embedded memory, input output interface, and various other circuitries as known in the art. The system 100 includes at least one memory 120 (e.g., a volatile memory device, and/or a non-volatile memory device). System 100 includes a storage device 140, which may include non-volatile memory and/or volatile memory, including, but not limited to, EEPROM, ROM, PROM, RAM, DRAM, SRAM, flash, magnetic disk drive, and/or optical disk drive. The storage device 140 may include an internal storage device, an attached storage device, and/or a network accessible storage device, as non-limiting examples.

System 100 includes an encoder/decoder module 130 configured, for example, to process data to provide an encoded video or decoded video, and the encoder/decoder module 130 may include its own processor and memory. The encoder/decoder module 130 represents module(s) that may be included in a device to perform the encoding and/or decoding functions. As is known, a device may include one or both of the encoding and decoding modules. Additionally, encoder/decoder module 130 may be implemented as a separate element of system 100 or may be incorporated within processor 110 as a combination of hardware and software as known to those skilled in the art.

Program code to be loaded onto processor 110 or encoder/decoder 130 to perform the various aspects described in this application may be stored in storage device 140 and subsequently loaded onto memory 120 for execution by processor 110. In accordance with various embodiments, one or more of processor 110, memory 120, storage device 140, and encoder/decoder module 130 may store one or more of various items during the performance of the processes described in this application. Such stored items may include, but are not limited to, the input video, the decoded video or portions of the decoded video, the bitstream, matrices, variables, and intermediate or final results from the processing of equations, formulas, operations, and operational logic.

In several embodiments, memory inside of the processor 110 and/or the encoder/decoder module 130 is used to store instructions and to provide working memory for processing that is needed during encoding or decoding. In other embodiments, however, a memory external to the processing device (for example, the processing device may be either the processor 110 or the encoder/decoder module 130) is used for one or more of these functions. The external memory may be the memory 120 and/or the storage device 140, for example, a dynamic volatile memory and/or a non-volatile flash memory. In several embodiments, an external non-volatile flash memory is used to store the operating system of a television. In at least one embodiment, a fast external dynamic volatile memory such as a RAM is used as working memory for video coding and decoding operations, such as for MPEG-2, MPEG-4, HEVC, or VVC.

The input to the elements of system 100 may be provided through various input devices as indicated in block 105. Such input devices include, but are not limited to, (i) an RF portion that receives an RF signal transmitted, for example, over the air by a broadcaster, (ii) a Composite input terminal, (iii) a USB input terminal, and/or (iv) an HDMI input terminal.

In various embodiments, the input devices of block 105 have associated respective input processing elements as known in the art. For example, the RF portion may be associated with elements suitable for (i) selecting a desired frequency (also referred to as selecting a signal, or band-limiting a signal to a band of frequencies), (ii) down converting the selected signal, (iii) band-limiting again to a narrower band of frequencies to select (for example) a signal frequency band which may be referred to as a channel in certain embodiments, (iv) demodulating the down converted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion may include a tuner that performs various of these functions, including, for example, down converting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, down converting, and filtering again to a desired frequency band. Various embodiments rearrange the order of the above-described (and other) elements, remove some of these elements, and/or add other elements performing similar or different functions. Adding elements may include inserting elements in between existing elements, for example, inserting amplifiers and an analog-to-digital converter. In various embodiments, the RF portion includes an antenna.

Additionally, the USB and/or HDMI terminals may include respective interface processors for connecting system 100 to other electronic devices across USB and/or HDMI connections. It is to be understood that various aspects of input processing, for example, Reed-Solomon error correction, may be implemented, for example, within a separate input processing IC or within processor 110 as necessary. Similarly, aspects of USB or HDMI interface processing may be implemented within separate interface ICs or within processor 110 as necessary. The demodulated, error corrected, and demultiplexed stream is provided to various processing elements, including, for example, processor 110, and encoder/decoder 130 operating in combination with the memory and storage elements to process the datastream as necessary for presentation on an output device.

Various elements of system 100 may be provided within an integrated housing. Within the integrated housing, the various elements may be interconnected and transmit data therebetween using suitable connection arrangement 115, for example, an internal bus as known in the art, including the I2C bus, wiring, and printed circuit boards.

The system 100 includes communication interface 150 that enables communication with other devices via communication channel 190. The communication interface 150 may include, but is not limited to, a transceiver configured to transmit and to receive data over communication channel 190. The communication interface 150 may include, but is not limited to, a modem or network card and the communication channel 190 may be implemented, for example, within a wired and/or a wireless medium.

Data is streamed to the system 100, in various embodiments, using a Wi-Fi network such as IEEE 802.11. The Wi-Fi signal of these embodiments is received over the communications channel 190 and the communications interface 150 which are adapted for Wi-Fi communications. The communications channel 190 of these embodiments is typically connected to an access point or router that provides access to outside networks including the Internet for allowing streaming applications and other over-the-top communications. Other embodiments provide streamed data to the system 100 using a set-top box that delivers the data over the HDMI connection of the input block 105. Still other embodiments provide streamed data to the system 100 using the RF connection of the input block 105.

The system 100 may provide an output signal to various output devices, including a display 165, speakers 175, and other peripheral devices 185. The other peripheral devices 185 include, in various examples of embodiments, one or more of a stand-alone DVR, a disk player, a stereo system, a lighting system, and other devices that provide a function based on the output of the system 100. In various embodiments, control signals are communicated between the system 100 and the display 165, speakers 175, or other peripheral devices 185 using signaling such as AV. Link, CEC, or other communications protocols that enable device-to-device control with or without user intervention. The output devices may be communicatively coupled to system 100 via dedicated connections through respective interfaces 160, 170, and 180. Alternatively, the output devices may be connected to system 100 using the communications channel 190 via the communications interface 150. The display 165 and speakers 175 may be integrated in a single unit with the other components of system 100 in an electronic device, for example, a television. In various embodiments, the display interface 160 includes a display driver, for example, a timing controller (T Con) chip.

The display 165 and speaker 175 may alternatively be separate from one or more of the other components, for example, if the RF portion of input 105 is part of a separate set-top box. In various embodiments in which the display 165 and speakers 175 are external components, the output signal may be provided via dedicated output connections, including, for example, HDMI ports, USB ports, or COMP outputs.

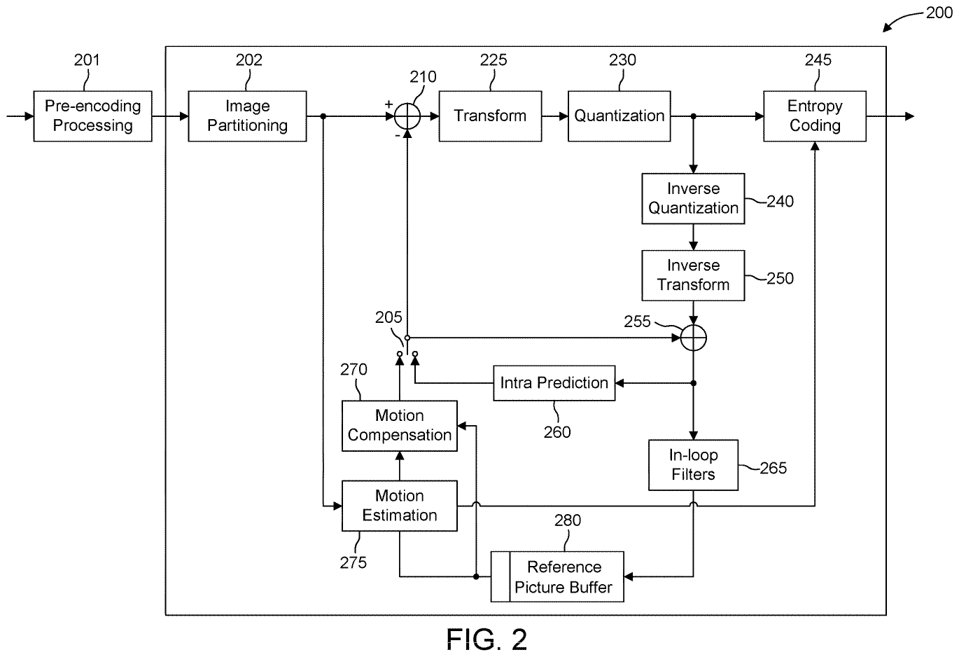

FIG. 2 illustrates an example video encoder 200, such as VVC (Versatile Video Coding) encoder. FIG. 2 may also illustrate an encoder in which improvements are made to the VVC standard or an encoder employing technologies similar to VVC.

In the present application, the terms “reconstructed” and “decoded” may be used interchangeably, the terms “encoded” or “coded” may be used interchangeably, and the terms “image,” “picture” and “frame” may be used interchangeably. Usually, but not necessarily, the term “reconstructed” is used at the encoder side while “decoded” is used at the decoder side.

Before being encoded, the video sequence may go through pre-encoding processing (201), for example, applying a color transform to the input color picture (e.g., conversion from RGB 4:4:4 to YCbCr 4:2:0), or performing a remapping of the input picture components in order to get a signal distribution more resilient to compression (for instance using a histogram equalization of one of the color components). Metadata can be associated with the pre-processing, and attached to the bitstream.

In the encoder 200, a picture is encoded by the encoder elements as described below. The picture to be encoded is partitioned (202) and processed in units of, for example, CUs. Each unit is encoded using, for example, either an intra or inter mode. When a unit is encoded in an intra mode, it performs intra prediction (260). In an inter mode, motion estimation (275) and compensation (270) are performed. The encoder decides (205) which one of the intra mode or inter mode to use for encoding the unit, and indicates the intra/inter decision by, for example, a prediction mode flag. Prediction residuals are calculated, for example, by subtracting (210) the predicted block from the original image block.

The prediction residuals are then transformed (225) and quantized (230). The quantized transform coefficients, as well as motion vectors and other syntax elements, are entropy coded (245) to output a bitstream. The encoder can skip the transform and apply quantization directly to the non-transformed residual signal. The encoder can bypass both transform and quantization, i.e., the residual is coded directly without the application of the transform or quantization processes.

The encoder decodes an encoded block to provide a reference for further predictions. The quantized transform coefficients are de-quantized (240) and inverse transformed (250) to decode prediction residuals. Combining (255) the decoded prediction residuals and the predicted block, an image block is reconstructed. In-loop filters (265) are applied to the reconstructed picture to perform, for example, deblocking/SAO (Sample Adaptive Offset) filtering to reduce encoding artifacts. The filtered image is stored at a reference picture buffer (280).

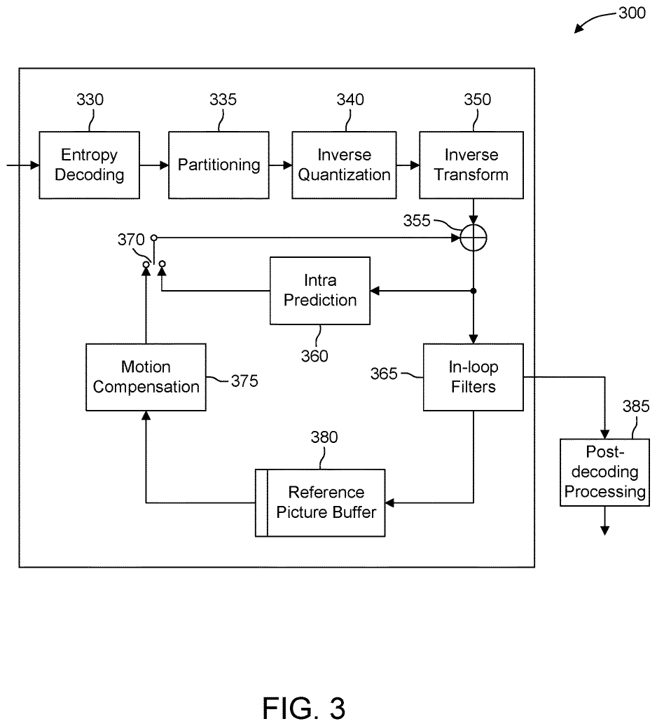

FIG. 3 illustrates a block diagram of an example video decoder 300, such as VVC decoder. In the decoder 300, a bitstream is decoded by the decoder elements as described below. Video decoder 300 generally performs a decoding pass reciprocal to the encoding pass as described in FIG. 2. The encoder 200 also generally performs video decoding as part of encoding video data.

In particular, the input of the decoder includes a video bitstream, which can be generated by video encoder 200. The bitstream is first entropy decoded (330) to obtain transform coefficients, motion vectors, and other coded information. The picture partition information indicates how the picture is partitioned. The decoder may therefore divide (335) the picture according to the decoded picture partitioning information. The transform coefficients are de-quantized (340) and inverse transformed (350) to decode the prediction residuals. Combining (355) the decoded prediction residuals and the predicted block, an image block is reconstructed. The predicted block can be obtained (370) from intra prediction (360) or motion-compensated prediction (i.e., inter prediction) (375). In-loop filters (365) are applied to the reconstructed image. The filtered image is stored at a reference picture buffer (380).

The decoded picture can further go through post-decoding processing (385), for example, an inverse color transform (e.g., conversion from YCbCr 4:2:0 to RGB 4:4:4) or an inverse remapping performing the inverse of the remapping process performed in the pre-encoding processing (201). The post-decoding processing can use metadata derived in the pre-encoding processing and signaled in the bitstream.

Depending on different applications, the requirements of video compression vary in practice. For example, in tasks mainly for human consumption such as video conferencing, faces of a human-centric video need to be restored with high-perceptual-quality so that the decoded video looks realistic and pleasant to human eyes. In tasks mainly for machine consumption such as face recognition in surveillance, identity-preserving cues need to be restored so that decoded videos can maintain the recognition accuracy for further analysis by machine. Previous compression methods, in general, treat different applications separately, where a video coding framework is customized for either human consumption or machine consumption. The U.S. patent application 63/447,697 filed on Feb. 23, 2023, by the same applicant describes a framework for encoding/decoding a video that provides, for content such as human-centric video, an adaptive video coding scheme that can be flexibly configured to accommodate both human and machine consumption. As prior works described in the next section mostly rely on a different approach to generate faces, no syntax structure exists that efficiently describes the elements necessary to reconstruct the human faces, or other regions/objects that the framework of the U.S. patent application 63/447,697 addresses.

For general human-centric video compression, given a set of input video frames I₁ . . . , I_{N}, an encoder generates a compressed representation Lᵢ for each video frame Iᵢ, which requires less bits than the original input video frame Iᵢ to send to a decoder. It can correspond to a filtered or degraded version of the image which makes it more compressible, or a sub-sampled version. The encoder recovers the output video frame Îᵢ based on the received compressed representation Lᵢ, and the previously received Lᵢ . . . , Lᵢ₋₁. For applications targeting human consumption, the goal is to minimize both the restoration distortion D(Iᵢ, Îᵢ) (e.g., MSE or SSIM) and the bitrate R(Lᵢ). For applications targeting at machine consumption, the goal is to minimize the task loss L(Îᵢ) (e.g., recognition errors) and the bitrate R(Lᵢ).

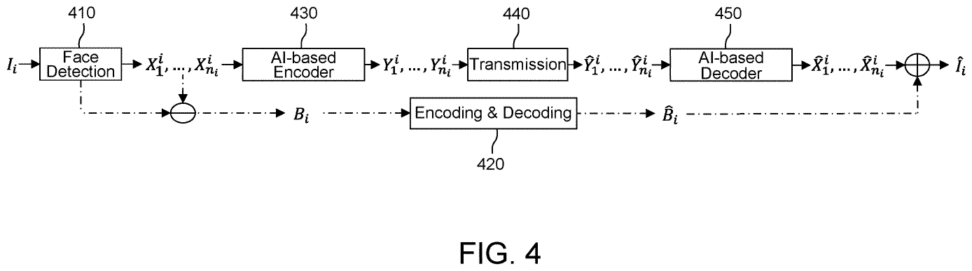

FIG. 4 illustrates a general workflow of AI-based human-centric video compression system according to an embodiment. This general workflow relies on the extraction of a region that includes the subject which can be compressed by generative approaches. In the following, we consider the example of human faces. Each input frame Iᵢ is fed into a Face Detection module 410 and human faces

$${X}_{1}^{i} , ... , {X}_{{n}_{i}}^{i}$$

are detected. Each face

$${X}_{j}^{i}$$

is a cropped region in Iᵢ defined by a bounding box, usually a square box or a rectangular box, containing the detected human face in the center with some extended areas. For example, the region is centered at the center of the detected face and the width and height of the bounding box are a times and b times of the width and height of the face respectively (a≥1, b≥1). The present aspects do not put any restrictions on the face detection method or how to crop the bounding box of the face region. Also, one can decide to only consider some detected faces (e.g., the largest faces or the faces in the center of the video frame). The present aspects do not put restrictions on how many faces or what faces to consider either.

Let Bᵢ denote the remaining background pixels in frame Iᵢ that are not included in any of the human faces one decides to consider. There can be different ways for the video compression system to process Bᵢ. For example, an optional Encoding & Decoding module 420 can aggressively compress Bᵢ by traditional compression standards (such as HEVC/VVC as non-limiting examples) as described with FIG. 2 and FIG. 3, or end-to-end Learned Image Coding LIC, or NN-based learned video coding, which is then transmitted to the decoder where a decoded \hat{B}ᵢ can be obtained. In some cases, Bᵢ can be simply discarded, e.g., when a predefined virtual background is used.

According to a variant, the compression framework for the background Bᵢ may be an existing video compression standard to which is added metadata that includes the information required to pilot the AI-based codec for the faces. In that case, the AI-based encoder, decoder and the combination with the background may be seen as an external process to the compression standard. Besides, in this variant, the metadata may be conveyed using Supplemental Enhancement Information (SEI) messages which do not impact the standard decoding process.

According to another variant, the overall framework may be a novel multi-task codec in which the compression scheme of the faces itself is normative. In that case, the AI-based decoder for faces consists of a normative method and the related codebook information and other combining weights are fully (mandatory) part of the multi-layer bitstream.

However, in both cases, the bitstream parts coding for face boxes

$${X}_{1}^{i} , ... , {X}_{{n}_{i}}^{i}$$

do not exist in the context of multi-task compression as described in U.S. patent application 63/447,697. A method that conveys information enabling a decoder to reconstruct human faces based on the codebook-based branches as described in the U.S. patent application 63/447,697 when combined with video compression standards is therefore desirable.

Back to FIG. 4, for each face

$${X}_{j}^{i} , j = 1 , ... , {n}_{i}$$

to consider, on the encoder side, an AI-Based Encoder 430 computes a corresponding latent representation

$${Y}_{j}^{i} , j = 1 , ... , {n}_{i} ,$$

which usually consumes less bits to transfer by a Transmission module 440, which also computes a recovered latent representation

$${\hat{Y}}_{j}^{i} , j = 1 , ... , {n}_{i}$$

on the decoder side. Usually, the latent representation

$${Y}_{j}^{i}$$

is further compressed in the Transmission module before transmission, e.g., by lossless arithmetic coding, and a corresponding decoding process is needed to recover

$${\hat{Y}}_{j}^{i}$$

in the Transmission module 440. Based on the recovered latent representation

$${\hat{Y}}_{j}^{i} , j = 1 , ... , {n}_{i} ,$$

an AI-Based Decoder 450 reconstructs the output face

$${\hat{X}}_{j}^{i} , j = 1 , ... , {n}_{i} .$$

In the variant where a decoded background [symbol] is provided, the output face

$${\hat{X}}_{j}^{i} , j = 1 , … , {n}_{i}$$

is merged back with [symbol] to generate the final reconstructed frame Îᵢ. The present aspects do not put any restriction on how to merge

$${\hat{X}}_{j}^{i} , j = 1 , … , {n}_{i}$$

with \hat{B}ᵢ.

Compression of human faces using generative approaches have also been proposed in the literature. One of the most popular frameworks uses a video or an image codec to compress key frames, which will serve as reference for a deep generative model that synthesizes the subsequent frames. For instance, some prior AI-based video compression solutions for human consumption are based on the idea of face reenactment, which transfers the facial motion of one driving face image to another source face image. In that case, given the video frames I₁ . . . , I_{N}, faces

$${X}_{j}^{i}$$

with j=1, . . . , nᵢ and i=1, . . . , M in the first M frames (with 1≤M<N) are transmitted to the Decoder with high bitrates to ensure the quality of the decoded faces, by using traditional HEVC/VVC, or LIC or video coding methods. These faces are called source features, which carry the appearance and texture information of the person in the video (assuming consistent visual appearance of the person in the same video). For example, M=1, meaning that the faces (ie the one or more faces) in only one frame are transmitted or for another example, M>1. Then, the faces in the remaining frames

$${X}_{j}^{l} , j = 1 , … , {n}_{l} , l = M + 1 , … , N$$

are called driving faces. Facial landmark keypoints such as on left and right eyes, nose, eyebrows, lips, etc. are extracted from both source frames and driving frames, which carry the pose and expression information of the person. Usually some additional information, such as the 3D head pose, is also computed from both the source and the driving frames. Then for face [symbol] in the driving frame Iₗ, using a corresponding face [symbol] in the source frame Iᵢ, based on the computed 3D head pose and landmark keypoints, a transformation function can be learned to transfer the pose and expression of the driving face [symbol] to the source face [symbol] and a reenactment neural network is used to generate the output reenacted face

$${X}_{j}^{li} .$$

Then multiple reenacted faces

$${X}_{j}^{li} , i = 1 , … , M$$

using multiple source faces are combined by interpolation to obtain the final output face

$${\hat{X}}_{j}^{l} .$$

A syntax has been proposed in the context of the JVET activity for transmitting information on face key point. For instance, key point information and other spatial elements may be transmitted within an SEI message, along with an existing or future ITU/MPEG bitstream (e.g., H.265/HEVC, H.266/VVC or other future standard). SEI messages are optional as they do not impact the decoding process. The main bitstream may be decoded using core standard operations. Enhancement may be applied by a post-processor at the receiver on the decoded content, using the information conveyed in SEI messages.

An example of a syntax table is reproduced below:

| | Descriptor |
|---|---|
| Generative_face_video ( payloadSize ) { | |
| gfv_id | ue(v) |
| gfv_num_set_of_parameter | ue(v) |
| gfv_quantization_factor | ue(v) |
| gfv_head_location_present_flag | u(1) |
| gfv_head_rotation_present_flag | u(1) |
| gfv_head_translation_present_flag | u(1) |
| gfv_eye_blinking_present_flag | u(1) |
| gfv_mouth_motion_present_flag | u(1) |
| for( i=0; i< gfv_num_set_of_parameter;i++){ | |
| if(gfv_head_location_present_flag==1){ | |
| gfv_location[i] | ue(v) |
| } | |
| if(gfv_head_rotation_present_flag==1){ | |
| gfv_rotation_roll [i] | ue(v) |
| gfv_rotation_pitch[i] | ue(v) |
| gfv_rotation_yaw[i] | ue(v) |
| } | |
| if(gfv_head_translation_present_flag==1){ | |
| gfv_translation_x[i] | ue(v)/’ |
| gfv_translation_y[i] | ue(v) |
| gfv_translation_z[i] | ue(v) |
| } | |
| if(gfv_eye_blinking_present_flag==1){ | |
| gfv_eye[i] | ue(v) |
| } | |
| if(gfv_mouth_motion_present_flag==1){ | |
| gfv_mouth_para1[i] | ue(v) |
| gfv_mouth_para2[i] | ue(v) |
| gfv_mouth_para3[i] | ue(v) |
| gfv_mouth_para4[i] | ue(v) |
| gfv_mouth_para5[i] | ue(v) |
| gfv_mouth_para6[i] | ue(v) |
| } | |
| } | |
| } | |

The referenced syntax elements are defined as follows:
gfv_id contains an identifying number that may be used to identify a generative face video filter. The value of gfv_id shall be in the range of 0 to 2³²−2, inclusive.
gfv_num_set_of_parameter specifies the number of parameter sets in the SEI message. One set of parameters is used to generate one face picture. The value of gfv_num_set_of_parameter shall be in the range of 0 to 2¹⁰, inclusive.
gfv_quantization_factor specifies quantization factor to process the face information paramter (i.e., gfv_location[i], gfv_rotation_roll[i], gfv_rotation_pitch[i], gfv_rotationg_yaw[i], gfv_translation_x[i], gfv_translation_y[i], gfv_translation_z[i], gfv_eye[i], gfv_mouth_para1[i], gfv_mouth_para2[i], gfv_mouth_para3[i], gfv_mouth_para4[i], gfv_mouth_para5[i] and gfv_mouth_para6[i]). The values of paramaters used for face generation are equal to the values of corresponding syntax elements divided by gfv_quantization_factor.
Note: For example, if the value of gfv_location[i] is 1234, and the value of gfv_quantization_factor is 10000, the parameter actually used for gfv_location[i] is 0.1234.
gfv_head_location_present_flag equal to 1 indicates gfv_location[i] is present. gfv_head_location_present_flag equal to 0 indicates gfv_location[i] is not present.
gfv_location[i], when i is not equal to 0, specifies the quantized residual corresponding to head location between the i-th face picture and (i−1)-th face picture via gfv_quantization_factor in display order. When i is equal to 0, gfv_location[0] specifies the quantized head location parameter of 0-th face picture.
gfv_head_rotation_present_flag equal to 1 indicates gfv_rotation_roll[i], gfv_rotation_pitch[i], gfv_rotation_yaw[i] are present and gfv_head_rotation_flag equal to 0 indicates gfv_rotation_roll[i], gfv_rotation_pitch[i], gfv_rotation_yaw[i] are not present.
gfv_rotation_roll[i], when i is not equal to 0, specifies the quantized residual corresponding to head rotation around the front-to-back axis (called roll) between the i-th face picture and (i−1)-th face picture via gfv_quantization_factor in display order. When i is equal to 0, gfv_rotation_roll[0] specifies the quantized front-to-back-axis head rotation parameter of 0-th face picture.
gfv_rotation_pitch[i], when i is not equal to 0, specifies the quantized residual corresponding to head rotation around the side-to-side axis (called pitch) between the i-th face picture and (i−1)-th face picture via gfv_quantization_factor in display order. When i is equal to 0, gfv_rotation_pitch[0] specifies the quantized side-to-side-axis head rotation parameter of 0-th face picture.
gfv_rotation_yaw[i], when i is not equal to 0, specifies the quantized residual corresponding to head rotation around the vertical axis (called yaw) between the i-th face picture and (i−1)-th face picture via gfv_quantization_factor in display order. When i is equal to 0, gfv_rotation_yaw[0] specifies the quantized vertical-axis head rotation parameter of 0-th face picture.
gfv_head_translation_present_flag equal to 1 indicates gfv_translation_x[i], gfv_translation_y[i] and gfv_translation_z[i] are present and gfv__head_translation_flag equal to 0 indicates gfv_translation_x[i], gfv_translation_y[i] and gfv_translation_z[i] are not present.
gfv_translation_x[i], when i is not equal to 0, specifies the quantized residual corresponding to head translation around the x axis between the i-th face picture and (i−1)-th face picture via gfv_quantization_factor in display order. When i is equal to 0, gfv_translation_x[0] specifies the quantized x-axis head translation parameter of 0-th face picture.
gfv_translation_y[i], when i is not equal to 0, specifies the quantized residual corresponding to head translation around the y axis between the i-th face picture and (i−1)-th face picture via gfv_quantization_factor in display order. When i is equal to 0, gfv_translation_y[0] specifies the quantized y-axis head translation parameter of 0-th face picture.
gfv_translation_z[i], when i is not equal to 0, specifies the quantized residual corresponding to head translation around the z axis between the i-th face picture and (i−1)-th face picture via gfv_quantization_factor in display order. When i is equal to 0, gfv_translation_z[0] specifies the quantized z-axis head translation parameter from 0-th face picture.
gfv_eye_blinking_present_flag equal to 1 indicates gfv_eye[i] is present and gfv_eye_blinking_present_flag is equal to 0 indicates gfv_eye[i] is not present.
gfv_eye[i], when i is not equal to 0, specifies the quantized residual corresponding to eye blinking degree between the i-th face picture and (i−1)-th face picture via gfv_quantization_factor in display order. When i is equal to 0, gfv_eye[0] specifies the quantized eye blinking parameter of 0-th face picture.
gfv_mouth_motion_present_flag is equal to 1 indicates gfv_mouth_para1[i], gfv_mouth_para2[i], gfv_mouth_para3[i], gfv_mouth_para4[i], gfv_mouth_para5[i] and gfv_mouth_para6[i] are present and gfv_mouth_motion_present_flag equal to 0 indicates gfv_mouth_para1[i], gfv_mouth_para2[i], gfv_mouth_para3[i], gfv_mouth_para4[i], gfv_mouth_para5[i] and gfv_mouth_para6[i] are not present.
gfv_mouth_para1[i], when i is not equal to 0, specifies the quantized residual corresponding to mouth motion between the i-th face picture and (i−1)-th face picture via gfv_quantization_factor in display order. When i is equal to 0, gfv_mouth_para1[0] specifies the quantized mouth motion parameter of 0-th face picture.
gfv_mouth_para2[i], when i is not equal to 0, specifies the quantized residual corresponding to mouth motion between the i-th face picture and (i−1)-th face picture via gfv_quantization_factor in display order. When i is equal to 0, gfv_mouth_para2[0] specifies the quantized mouth motion parameter of 0-th face picture.
gfv_mouth_para3[i], when i is not equal to 0, specifies the quantized residual corresponding to mouth motion between the i-th face picture and (i−1)-th face picture via gfv_quantization_factor in display order. When i is equal to 0, gfv_mouth_para3[0] specifies the quantized mouth motion parameter of 0-th face picture.
gfv_mouth_para4[i], when i is not equal to 0, specifies the quantized residual corresponding to mouth motion between the i-th face picture and (i−1)-th face picture via gfv_quantization_factor in display order. When i is equal to 0, gfv_mouth_para4[0] specifies the quantized mouth motion parameter from 0-th face picture.
gfv_mouth_para5[i], when i is not equal to 0, specifies the quantized residual corresponding to mouth motion between the i-th face picture and (i−1)-th face picture via gfv_quantization_factor in display order. When i is equal to 0, gfv_mouth_para5[0] specifies the quantized mouth motion parameter from 0-th face picture.
gfv_mouth_para6[i], when i is not equal to 0, specifies the quantized residual corresponding to mouth motion between the i-th face picture and (i−1)-th face picture via gfv_quantization_factor in display order. When i is equal to 0, gfv_mouth_para6[0] specifies the quantized mouth motion parameter from 0-th face picture.

This syntax may be coupled with a face-reenactment-based solution like the one presented above. However, this approach still presents severe flaws when applied to realistic faces in the wild. First, due to the difficulty in generating real hair, teeth, accessories, etc., which cannot be accurately described by the facial key points only, artifacts are often inevitable. By only applying the reenactment process to the tightly cropped or segmented face regions, the artifacts can be reduced but not eliminated, with additional computation and transmission overhead. In addition, prior solutions are innately unstable, because the reenacted face relies on the appearance and texture information from the source frame and the pose and expression information from another driving frame. The performance suffers from large discrepancy between the source and target faces caused by changes of illuminations, pose, expressions, etc.

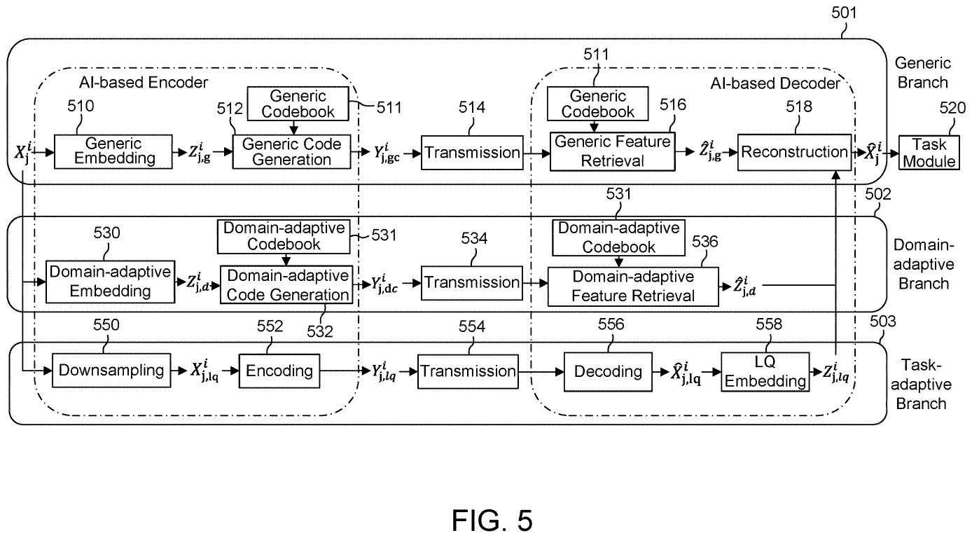

FIG. 5 illustrates a workflow of a novel human-centric video coding solution according to an embodiment. At least one embodiment proposes a novel human-centric video compression framework based on multi-task face restoration. This approach described the U.S. patent application 63/447,697 overcome the limitations of key-point-based approaches described in the previous section by relying large dictionaries of face features that the decoder can use, together with indications transmitted by the encoder, to reconstruct the faces. This codebook-based approach can be mixed with other adaptive branches as well as traditional methods to convey high fidelity details. At the decoder, the system generates the output video. As shown on FIG. 5, three processing branches among a generic branch, a domain-adaptive branch, and a task-adaptive branch, compose the proposed framework and are detailed in the next paragraphs. The first two can be based on codebook-based approaches.

For each input face

$${X}_{j}^{i} ,$$

the generic branch 501 generates and transmits a generic integer vector

$${Y}_{j , gc}^{i}$$

indicating the indices of a set of generic codewords. From the generic integer vector the decoder retrieves a rich High Quality (HQ) generic codebook-based feature

$${\hat{Z}}_{j , g}^{i}$$

based on the same HQ generic codebook shared with the encoder. A baseline HQ face can be robustly restored using the HQ generic codebook-based feature.

The domain-adaptive branch 502 generates and transmits a domain-adaptive integer vector

$${Y}_{j , dc}^{i}$$

indicating the indices of a set of domain-adaptive codewords. From the domain-adaptive integer vector, the decoder retrieves a domain-adaptive codebook-based feature based on the same domain-adaptive codebook shared with the encoder. This domain-adaptive codebook-based feature

$${\hat{Z}}_{j , d}^{i}$$

can be combined with the HQ generic codebook-based feature

$${\hat{Z}}_{j , g}^{i}$$

to restore a domain-adaptive face that preserves the details and expressiveness of the current face for the current task domain more faithfully. Advantageously, the HQ generic codebook is learned based on a large amount of HQ training faces to ensure high perceptual quality for human eyes. The domain-adaptive codebook is learned based on a set of training faces for the current task domain, e.g., for face recognition in surveillance videos using low-quality web cameras. The domain-adaptive codebook-based feature provides additional fidelity cues tuned to the current task domain.

Finally, the task-adaptive branch 503 computes task-adaptive features

$${Z}_{j , lq}^{i}$$

using a Low-Quality (LQ) low-bitrate face input that is usually downsized from the original input and then compressed aggressively by LIC or off-the-self VVC/HEVC compression scheme. This LQ feature is combined with the HQ generic codebook-based feature

$${\hat{Z}}_{j , g}^{i}$$

and optionally with the domain-adaptive codebook-based feature

$${\hat{Z}}_{j , d}^{i}$$

for final restoration. In other words, the proposed framework always restores an output face, which is fed into the end-task module to perform computer vision tasks, e.g., to be viewed by human or analyzed by machine.

Compared to prior video coding for machine consumption workflows, the proposed framework advantageously has the flexibility of accommodating different domains and different computer vision tasks by using the LQ feature to tailor the restored face towards different tasks' needs. For example, for video conferencing, the LQ feature can provide additional fidelity details to restore a face more faithful to the current facial shape and expression. In another example, for face recognition, the LQ feature can provide additional discriminative cues to preserve the identity of the current person. The LQ feature also provides flexibility to balance the bitrate and the desired task quality. For ultra-low bitrate, the system relies more on codebook-based features by assigning a lower weight to the LQ feature. With higher bitrate, a better LQ feature can be obtained, and a larger weight gives better task quality.

As shown in FIG. 5, first, in the Generic Branch 501, the system is given the input frame

$${X}_{j}^{i}$$

of size

$${h}_{j , in}^{i} \times {w}_{j , in}^{i} \times {k}_{i n}$$

where

$${h}_{j , in}^{i} , {w}_{j , in}^{i}$$

are the height, width, and the number of channels, respectively. For example, kᵢₙ=3 for RGB color image, kᵢₙ=1 for grey image, kᵢₙ=4 for a RGB color image plus Depth image, etc. A Generic Embedding module 510 computes a generic embedded feature

$${Z}_{j , g}^{i}$$

of size

$${h}_{j g}^{i} \times {w}_{j g}^{i} \times {k}_{g} .$$

The Generic Embedding module 510 typically is a Neural Network (NN) consisting of several computational layers such as convolution, (non-)linear activation, normalization, attention, skip connection, resizing, etc. The height

$${h}_{j g}^{i}$$

and width

$${w}_{j g}^{i}$$

of the generic embedded feature

$${Z}_{j , g}^{i}$$

depends on the size of input image as well as the network structure of the Generic Embedding module 510, and the number of feature channels k_{g} depends on the network structure of the Generic Embedding module 610. The encoder is provided with a learnable generic codebook 511 [symbol] _{g}={c_{g1}, . . . , c_{gm}_{_{g}}} containing m_{g} codewords. Each codeword c_{gl} is represented as a kg dimensional feature vector. Then a Generic Code Generation module 512 computes a generic codebook-based representation

$${Y}_{j , g c}^{i}$$

based on the generic embedded feature

$${Z}_{j , g}^{i}$$

and the generic codebook [symbol] _{g}. Specifically, each element

$${z}_{j , g}^{i} ( u , v ) in {Z}_{j , g}^{i} ( u = 1 , … , {h}_{j g}^{i} , v = 1 , … , {w}_{j g}^{i} )$$

is also a k_{g} dimensional feature vector, which is mapped to an optimal codeword c_{gidx(u,v)} (u, v) closest to

$${z}_{j , g}^{i} ( u , v ) :$$

$$idx ( u , v ) = {argmin}_{l = 1}^{{m}_{g}} D ( {z}_{j , g}^{i} ( u , v ) , {c}_{gl} ) , \qquad ( 1 )$$

where

$$D ( {z}_{j , g}^{i} ( u , v ) , {c}_{g l} )$$

is the distance between

$${z}_{j , g}^{i} ( u , v )$$

and c_{gl} (e.g., L2 distance). That is,

$${z}_{j , g}^{i} ( u , v )$$

can be approximated by the codeword index idx(u, v), and the generic embedded feature

$${Z}_{j , g}^{i}$$

can be represented by the approximate integer generic codebook-based representation

$${Y}_{j , gc}^{i}$$

comprising

$${h}_{jg}^{i} \times {w}_{jg}^{i}$$

codeword indices. This integer generic codebook-based representation

$${Y}_{j , gc}^{i}$$

consumes few bits compared to the original

$${X}_{j}^{i}$$

to transfer.

Similarly, in the Domain-Adaptive Branch 502, a Domain-Adaptive Embedding module 530 computes a domain-adaptive embedded feature

$${Z}_{j , d}^{i}$$

of size

$${h}_{jd}^{i} \times {w}_{jd}^{i} \times {k}_{d}$$

based on the input

$${X}_{j}^{i} .$$

The Domain-Adaptive Embedding module 530 typically is a NN consisting of several computational layers such as convolution, (non-)linear activation, normalization, attention, skip connection, resizing, etc. The height

$${h}_{jd}^{i}$$

and width

$${w}_{jd}^{i}$$

of the domain-adaptive embedded feature

$${Z}_{j , d}^{i}$$

depends on the size of input image as well as the network structure of the Domain-Adaptive Embedding module 530, and the number of feature channels k_{d} depends on the network structure of the Domain-Adaptive Embedding module. The encoder is also provided with a learnable domain-adaptive codebook 531 [symbol] _{d}={c_{d1}, . . . , c_{dm}_{_{d}}} containing m_{d} codewords. Each codeword c_{dl} is represented as a k_{d} dimensional feature vector. Then a Domain-Adaptive Code Generation module 532 computes a domain-adaptive codebook-based representation

$${Y}_{j , dc}^{i}$$

based on the domain-adaptive embedded feature

$${Z}_{j , d}^{i}$$

and the domain-adaptive codebook [symbol] _{d}. Specifically, each element

$${z}_{j , d}^{i} ( u , v ) in {Z}_{j , d}^{i} ( u = 1 , … , {h}_{jd}^{i} , v = 1 , … , {w}_{jd}^{i} )$$

is also a k_{d} dimensional feature vector, which is mapped to an optimal codeword c_{didx(u,v)}(u, v) closest to

$${z}_{j , d}^{i} ( u , v ) :$$

$$idx ( u , v ) = {argmin}_{l = 1}^{{m}_{d}} D ( {z}_{j , d}^{i} ( u , v ) , {c}_{dl} ) , \qquad ( 2 )$$

where

$$D ( {z}_{j , d}^{i} ( u , v ) , {c}_{dl} )$$

is the distance between

$${z}_{j , d}^{i} ( u , v )$$

and c_{dl} (e.g., L2 distance). That is,

$${z}_{j , d}^{i} ( u , v )$$

can be approximated by the codeword index idx(u, v), and the domain-adaptive embedded feature

$${Z}_{j , d}^{i}$$

can be represented by the approximate integer domain-adaptive codebook-based representation

$${I}_{j , d c}^{i}$$

comprising

$${h}_{j d}^{i} \times {w}_{jd}^{i}$$

codeword indices. This integer domain-adaptive codebook-based representation

$${Y}_{j , d c}^{i}$$

also consumes few bits compared to the original [symbol] to transfer.

In the Task-Adaptive Branch 503, the input [symbol] is downsampled by a scale of s (e.g., 4 times along both height and width) in a Downsampling module 550 to obtain a low-quality image/input (also simply referred to “low-quality” or LQ in the present application)

$${X}_{j , lq}^{i}$$

of size

$$\frac{{h}_{j , in}^{i}}{s} \times \frac{{w}_{j , in}^{i}}{s} \times {k}_{in} .$$

For example, a bicubic/bilinear filter can be used to perform downsampling, however the present aspects do not put any constraint on the downsampling method. Then the low-quality

$${X}_{j , lq}^{i}$$

is aggressively compressed by an Encoding module 552 to compute a low-quality latent representation

$${Y}_{j , lq}^{i}$$

for transmission. The Encoding module 552 can use various methods to compress the low-quality

$${X}_{j , lq}^{i}$$

For example, an NN-based LIC method may be used. In another variant, a traditional video coding tool like HEVC/VVC may also be used. In that case, the skilled in the art will appreciate that the low-quality latent representation is rather a low-quality representation as no NN-based process is involved in the coding. In an embodiment, the compression rate is high so that the low-quality LQ latent representation

$${Y}_{j , lq}^{i}$$

consumes little bits. The present aspects do not put any restrictions on the specific method or the compression settings of the method used to compress the low-quality

$${X}_{j , lq}^{i} .$$

Finally, the generic codebook-based representation

$${Y}_{j , gc}^{i} ,$$

the domain-adaptive codebook-based representation

$${Y}_{j , d c}^{i} ,$$

and the low-quality latent representation

$${Y}_{j , lq}^{i}$$

together form the latent representation

$${Y}_{j}^{i}$$

as represented in FIG. 4, which is transmitted to the decoder. According to a variant embodiment, at the same time, domain-adaptive combining weights

$${W}_{j , dc}^{i}$$

(associated with

$${Y}_{j , dc}^{i}$$

) and LQ combining weights

$${W}_{j , lq}^{i}$$

(associated with

$${Y}_{j , lq}^{i}$$

) may also be sent to the decoder, which will be used to guide the decoding process.

On the decoder side, first, in the Generic Branch 501, after receiving the generic codebook-based representation

$${Y}_{j , gc}^{i} ,$$

a Generic Feature Retrieval module 516 retrieves the corresponding codeword c_{gidx(u,v)}(u, v) for each index idx(u, v) to form the decoded embedding feature

$${\hat{Z}}_{j , g}^{i}$$

of size

$${h}_{jg}^{i} \times {w}_{jg}^{i} \times {k}_{g} ,$$

based on the same codebook

$${ℂ}_{g} = \{ {c}_{g 1} , … , {c}_{{gm}_{g}} \}$$

as in the encoder. Similar to the generic branch, in the Domain-Adaptive Branch 502, after receiving the domain-adaptive codebook-based representation

$${Y}_{j , dc}^{i}$$

a Domain-Adaptive Feature Retrieval module 536 retrieves the corresponding codeword c_{didx(u,v)}(u, v) for each index idx(u, v) to form the decoded embedding feature

$${\hat{Z}}_{j , d}^{i}$$

of size

$${h}_{jd}^{i} \times {w}_{jd}^{i} \times {k}_{d} ,$$

based on the same codebook

$${ℂ}_{d} = \{ {c}_{d 1} , … , {c}_{{dm}_{d}} \}$$

as in the encoder. In the task-adaptive branch 503, after receiving the low-quality latent representation

$${Y}_{j , lq}^{i} ,$$

a Decoding module 556 decodes a decoded low-quality input

$${\hat{X}}_{j , lq}^{i}$$

using a decoding method corresponding to the encoding method used in the Encoding module 552. For example, an NN-based LIC method may be used. In a variant, any conventional image or video codecs such as HEVC, VVC, etc., may be used. Then an LQ Embedding module 558 computes a low-quality embedding feature

$${Z}_{j , lq}^{i}$$

of size

$${h}_{jlq}^{i} \times {w}_{jlq}^{i} \times {k}_{lq}$$

based on the decoded low-quality input

$${\hat{X}}_{j , lq}^{i} .$$

The LQ Embedding network 558 is similar to the Embedding module in the encoder, which typically is an NN including layers like convolution, non-linear activation, normalization, attention, skip connection, resizing, etc. This invention does not put any restrictions on the network architectures of the LQ Embedding module.

Given the decoded generic embedding feature

$${\hat{Z}}_{j , g}^{i} ,$$

the decoded domain-adaptive embedding feature

$${\hat{Z}}_{j , d}^{i} ,$$

and the low-quality embedding feature

$${Z}_{j , lq}^{i} ,$$

as well as the domain-adaptive combining weights

$${W}_{j , dc}^{i}$$

and the LQ combining weights

$${W}_{j , lq}^{i}$$

received from the encoder, a Reconstruction module 518 computes the reconstructed output

$${\hat{X}}_{j}^{i} .$$

In a variant embodiment, the Reconstruction module 518 may consist of several computational layers such as convolution, (non-)linear activation, normalization, attention, skip connection, resizing, etc. There are multiple ways to combine the decoded generic embedding feature

$${\hat{Z}}_{j , g}^{i} ,$$

the decoded domain-adaptive embedding feature

$${\hat{Z}}_{j , d}^{i} ,$$

and the low-quality embedding feature

$${Z}_{j , lq}^{i} .$$

According to a variant,

$${\hat{Z}}_{j , g}^{i} ,$$

$${\hat{Z}}_{j , d}^{i} ,$$

and

$${Z}_{j , lq}^{i}$$

may be designed to have the same width

$${w}_{j}^{i}$$

and height

$${h}_{j}^{i}$$

by designing the structure of the Generic Embedding module 510, the Domain-Adaptive Embedding module 520, and the LQ Embedding module 558. According to another variant, the decoded features

$${\hat{Z}}_{j , g}^{i} , {\hat{Z}}_{j , d}^{i} ,$$

and

$${Z}_{j , lq}^{i}$$

may be resized to have the same width

$${w}_{j}^{i}$$

and height

$${h}_{j}^{i}$$

through further convolution layers. Then

$${\hat{Z}}_{j , g}^{i} , {\hat{Z}}_{j , d}^{i} ,$$

and

$${Z}_{j , lq}^{i}$$

having a same two-dimensional dimension may be combined through concatenation, modulation, etc. According to a particular embodiment, different weights may be used in the combination. In a variant, the domain-adaptive combining weights

$${W}_{j , dc}^{i}$$

determines how important the decoded domain-adaptive codebook-based feature

$${\hat{Z}}_{j , d}^{i}$$

is when combined with the decoded generic codebook-based feature

$${\hat{Z}}_{j , g}^{i} .$$

In another variant, the LQ combining weights

$${W}_{j , l q}^{i}$$

determines how important the low-quality embedding feature

$${Z}_{j , lq}^{i}$$

is when combined with the decoded generic codebook-based feature

$${\hat{Z}}_{j , g}^{i}$$

and the decoded domain-adaptive codebook-based feature

$${\hat{Z}}_{j , d}^{i} .$$

The present aspects do not put any restrictions on the network architectures of the Reconstruction module 518 or the way to combine

$${\hat{Z}}_{j , g}^{i} , {\hat{Z}}_{j , d}^{i} ,$$

and

$${Z}_{j , lq}^{i} .$$

According to a particular feature, the domain-adaptive combining weights

$${W}_{j , dc}^{i}$$

and the LQ combining weights

$${W}_{j , lq}^{i}$$

are sent from the encoder to the decoder. The encoder can determine these weights in many ways. For example, the encoder can decide whether or not to compute the domain-adaptive embedding feature

$${Z}_{j , d}^{i}$$

and send the domain-adaptive codebook-based representation

$${Y}_{j , d c}^{i}$$

and the domain-adaptive combining weights

$${W}_{j , d c}^{i}$$

to decoder. Accordingly, in an embodiment, only the generic codebook-based representation

$${Y}_{j , gc}^{i}$$

and the low-quality latent representation

$${Y}_{j , lq}^{i}$$

together form the latent representation

$${Y}_{j}^{i}$$

of FIG. 4, which is transmitted to the decoder. Correspondingly, the Reconstruction module 518 will decide whether to use the decoded domain-adaptive codebook-based embedding feature

$${\hat{Z}}_{j , d}^{i}$$

to compute the restored face. Also, the encoder can decide whether or not to compute the low-quality latent representation

$${Y}_{j , lq}^{i}$$

in the Task-Adaptive Branch 503 and the LQ combining weights

$${Q}_{j , lq}^{i}$$

and transmit them to decoder. Accordingly, in this embodiment, only the generic codebook-based representation

$${Y}_{j , g c}^{i}$$

and the decoded domain-adaptive embedding feature

$${\hat{Z}}_{j , d}^{i}$$

together form the latent representation

$${Y}_{j}^{i}$$

of FIG. 4, which is transmitted to the decoder. Correspondingly the decoder will decide whether to compute the low-quality embedding feature

$${Z}_{j , lq}^{i}$$

and use it in the Reconstruction module to compute the restored face.

In one embodiment, the best performing

$${W}_{j , d c}^{i}$$

and/or

$${W}_{j , l q}^{i}$$

may be selected from a set of preset weight configurations based on a target performance metric (e.g., the Rate-Distortion tradeoff and/or the task performance metric like recognition accuracy). Also, in another embodiment,

$${W}_{j , dc}^{i}$$

and/or

$${W}_{j , lq}^{i}$$

may be selected for each video frame individually, or the system may determine

$${W}_{j , dc}^{i}$$

and/or

$${W}_{j , lq}^{i}$$

based on part of the video frames (e.g., the first frames of the video conferencing session) based on the averaged performance metric of these frames, and then fix the selected weights for the rest frames.

In brief, the skilled in the art will appreciate that the generic branch relies on a dictionary of faces in general and the generic branch allows reconstructing high perceptual quality faces, i.e., they can look visually realistic and pleasing but might not exactly correspond to the actual face in the input content. The second branch may embed details about the domain, i.e., the surrounding of the extracted face(s) in the video: changes of pose, color, lighting, etc. For each input face

$${X}_{j}^{i} ,$$

the generic branch generates and transmits a generic integer vector

$${Y}_{j , gc}^{i}$$

indicating the indices of a set of generic codewords. From the generic integer vector the decoder retrieves a rich High Quality (HQ) generic codebook-based feature

$${\hat{Z}}_{j , g}^{i}$$

based on the same HQ generic codebook shared with the encoder. A baseline HQ face can be robustly restored using the HQ generic codebook-based feature.

The domain-adaptive branch generates and transmits a domain-adaptive integer vector

$${Y}_{j , dc}^{i}$$

indicating the indices of a set of domain-adaptive codewords. From the domain-adaptive integer vector, the decoder retrieves a domain-adaptive codebook-based feature based on the same domain-adaptive codebook shared with the encoder. This domain-adaptive codebook-based feature

$${\hat{Z}}_{j , d}^{i}$$

may be combined with the HQ generic codebook-based feature

$${\hat{Z}}_{j , g}^{i}$$

to restore a domain-adaptive face region that preserves the details and expressiveness of the current face for the current task domain more faithfully.

Finally, the third one, called task-adaptive branch, contains the elements that enable to drive the reconstruction towards higher fidelity to the source faces. This branch may contain a low-resolution compressed version of the source face and can be compressed aggressively by Learned Video Compression methods or traditional codecs such as H.265/HEVC, H.266/VVC.

As mentioned above, a method is desirable that would provide the signaling of the codebook-based coding information, e.g., the generic and domain-adaptive branches described above, within a video bitstream which may be a bitstream according to an existing standard amended with a proposed enhancement message, a future multi-layer video codec, as well as an end-to-end Neural-Network-based compression model. This bitstream would carry the compressed video of the third branch which aims at bringing higher fidelity to the source faces. One would also recognize that the compression of the background and the combination with the generated/decompressed faces is out of the scope of the U.S. patent application 63/447,697.

At least one embodiment of the present principles relates to a bitstream comprising a low-quality representation of at least one region

$${X}_{j}^{i}$$

of a sequence of images along with metadata specifying at least one generic codebook-based representation

$${Y}_{j , gc}^{i} , {Y}_{j , dc}^{i}$$

of a generic feature

$${Z}_{j , g}^{i} , {Z}_{j , d}^{i}$$

of at least one region of the sequence of images, wherein the at least one generic codebook-based representation allows determining generic feature

$${Z}_{j , g}^{i} , {Z}_{j , d}^{i}$$

adapted to a plurality of computer vision tasks. In the following, the generic branch 601 and the domain adaptive branch 602 that generate the at least one generic codebook-based representation of a generic feature are also called generative branches. According to a non-limiting embodiment used in this disclosure, the images are human-centric images and the at least one region is a face region

$${X}_{j}^{i} .$$

According to a first embodiment, the task-adaptive branch and background are processed with a single codec. According to a second embodiment, the task-adaptive branch and the background are processed separately and then combined to reconstruct the entire frames, as described in the embodiments U.S. patent application 63/447,697 along with FIG. 5.

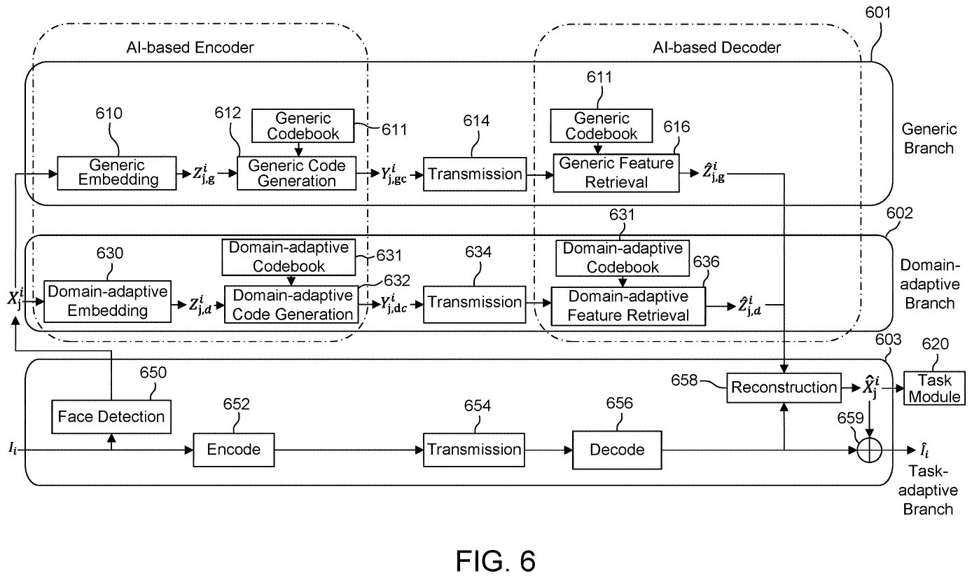

FIG. 6 illustrates a workflow of a novel human-centric video coding solution according to the first embodiment wherein the task-adaptive branch and background are processed with a single codec. Indeed, compared with FIG. 5, FIG. 6 illustrates the case where instead of having a dedicated codec for the background and one for the task adaptive branch 503, only one base codec is used on the whole frame Iᵢ. Accordingly, the low-quality representation of at least one region of a sequence of images comprises coded data including both the at least one region and the background of the at least one region of the sequence of images using a video compression standard. In that case, the generic and the domain branches 601, 602 as well as the reconstruction 658 and insertion 659 of face regions are out of the scope of the core decoder. Indeed, in the embodiment of FIG. 6, the detected faces [symbol] are still processed using the generic branch 601 and domain-adaptive branch 602. However, the reconstruction 658 of faces [symbol] at the decoder directly combines them with the regions coming from the base codec (bottom branch 603). In a variant, the reconstructed faces may then be inserted 659 in the output decoded image Îᵢ. In other variants, the reconstructed faces [symbol] may be used for downstream machine tasks 620. In yet another variant, both a decoded image Îᵢ with reconstructed faces may be output for display task and reconstructed faces may be output for downstream machine tasks 620.

In a variant of the first embodiment, metadata specifying at least one generic codebook-based representation of a generic feature

$${Z}_{j , g}^{i} , {Z}_{j , d}^{i}$$

of at least one region of the sequence of images are signaled as supplemental enhancement information SEI message, e.g. a SEI message of a video compression standard. For instance, the task adaptive branch 603 may use a video compression standard such as HEVC or VVC and include an SEI message which contains the different codewords to be transmitted in the generic and domain adaptive branches. According to a particular feature, metadata are signaled with an image of the sequence of images containing faces. Indeed, the persistence of that SEI may generally be one frame as the transmitted codewords vary from frame to frame, i.e., an SEI is transmitted along with every single frame of the video containing faces.

According to various embodiments, metadata specifying at least one generic codebook-based representation of a generic feature of at least one region of the sequence of images may comprises, either alone or in any combination, at least one of the following indications:
an indication specifying the number of regions to be processed by generative branches set;
an indication specifying the number of generative branches to be processed by generative branches set;
an indication specifying horizontal and vertical coordinates of top left corner of the at least one region;
an indication specifying horizontal and vertical size of the at least one region;
an indication identifying a generative branch to apply to the at least one region;
an indication specifying the weight that is used to merge the result of the j^{th} branch with the other branches;
an indication specifying a number of codeword indices to code the generic feature;
an indication values of codebook indices used to reconstruct the face according to the reconstruction process of the j^{th} branch.

An example of a syntax table for a multitask face video SEI message is reproduced below:

| | Descriptor |
|---|---|
| Multitask_face_video ( payloadSize ) { | |
| mfv_num_face_regions | ue(v) |
| mfv_num_of_generative_branches | u(8) |
| for( i=0; i< mfv_num_face_regions;i++){ | |
| mfv_x_coordinate [i] | ue(v) |
| mfv_y_coordinate [i] | ue(v) |
| mfv_x_size [i] | ue(v) |
| mfv_y_size [i] | ue(v) |
| } | |
| for( j=0; j< mfv_num_of_generative_branches[i];j++){ | |
| mfv_generative_branch_id[i][j] | ue(v) |
| mfv_combining_weight [i][j] | ue(v) |
| mfv_codeword_size[i][j] | ue(v) |
| for( k=0; k< mfv_codeword_size[i][j];k++){ | ue(v) |
| mfv_codeword[i][j][k] | ue(v) |
| } | |
| } | |

The syntax table being associated with the following semantics:
mfv_num_face_regions specifies the number of faces to be processed by generative branches set in the SEI message. The value of mfv_num_face_regions shall be in the range of 0 to 2¹⁰, inclusive.
mfv_num_generative_branches specifies the number of generative branches to be processed by generative branches set in the SEI message. The value of mfv_num_generative_branches parameter shall be in the range of 0 to 255, inclusive.
mfv_x_coordinate[i] specifies horizontal coordinate of top left corner of the box containing the i^{th} face. The value of mfv_x_coordinate[i] parameter shall be in the range of 0 to the frame width−2, inclusive.
mfv_y_coordinate[i] specifies horizontal coordinate of top left corner of the box containing the i^{th} face. The value of mfv_y_coordinate[i] parameter shall be in the range of 0 to the frame height−2, inclusive.
mfv_x_size[i] specifies horizontal size of the block containing the face. The value of mfv_x_size[i] parameter shall be in the range of 1 to the frame width, inclusive.
mfv_y_size[i] specifies horizontal size of the block containing the face. The value of mfv_y_size[i] parameter shall be in the range of 1 to the frame height, inclusive.
mfv_generative_branch_id[i][j] contains an identifying number that may be used to identify a generative face video branch. The value of mfv_generative_branch_id[i][j] shall be in the range of 0 to 2³²−2, inclusive.
mfv_combining_weight[i][j] specifies the weight that is used to merge the result of the j^{th} branch with the other branches.
mfv_codeword_size[i][j] specifies the number of codeword indices to code the face features.
mfv_codeword[i][j][k] values of codebook indices used to reconstruct the face according to the reconstruction process of the j^{th} branch.

The descriptors in the above table correspond to the following types in HEVC and VVC specifications:
u(n): unsigned integer using n bits. When n is “v” in the syntax table, the number of bits varies in a manner dependent on the value of other syntax elements. The parsing process for this descriptor is specified by the return value of the function read_bits(n) interpreted as a binary representation of an unsigned integer with most significant bit written first.
ue(v): unsigned integer 0-th order Exp-Golomb-coded syntax element with the left bit first. The parsing process is specified clause 9.2 of VVC with the order k equal to 0.

As described in the U.S. patent application 63/447,697 or illustrated with FIG. 5 or FIG. 6, for the branches relying on generative approaches, the encoder is provided with a learnable generic codebook 611, 631. For instance, for the generic branch 601, the codebook [symbol] _{g}={c_{g1}, . . . , c_{gm}_{_{g}}} contains m_{g} codewords. Each codeword c_{gl} is represented as a k_{g} dimensional feature vector. Then a Generic Code Generation module 612 computes a generic codebook-based representation

$${Y}_{j , gc}^{i}$$

based on the generic embedded feature

$${Z}_{j , g}^{i}$$

and the generic codebook [symbol] _{g}. Specifically, each element

$${z}_{j , g}^{i} ( u , v )$$

in

$${Z}_{j , g}^{i} ( u = 1 , … , {h}_{jg}^{i} , v = 1 , … , {w}_{j g}^{i} )$$

is also a k_{g} dimensional feature vector, which is mapped to an optimal codeword c_{gidx(u,v)}(u, v) closest to

$${z}_{j , g}^{i} ( u , v )$$

which can be approximated by a codeword index idx(u, v), and the generic embedded feature

$${Z}_{j , g}^{i}$$

can be represented by the approximate integer generic codebook-based representation

$${Y}_{j , gc}^{i}$$

comprising

$${h}_{j g}^{i} \times {w}_{j g}^{i}$$

codeword indices, where h and w are the height and width of the latent tensor representing embedded features.

As the shape of this tensor may depend on the generative model, it is proposed here to code the size mfv_codeword_size corresponding to

$${h}_{j g}^{i} \times {w}_{j g}^{i}$$

in the SEI so that the codeword indices can be parsed.

FIG. 7 illustrates a workflow of the reconstruction module according to an embodiment. According to a particular feature illustrated on FIG. 7, the reconstruction module 710 may use the transmitted combining weights

$${W}_{j , d}^{i} and / or {W}_{j , g}^{i}$$

corresponding to each generative branch to combine 720 the features

$${Z}_{j , d}^{i} , {Z}_{j , g}^{i}$$

The feature

$${Z}_{j , lq}^{i}$$

is generated from the decoded

$${\hat{X}}_{j , lq}^{i}$$

that corresponds to the case codec. In a variant embodiment, the proposed SEI may be used for key frames only, and then coupled with the method presented with key points to animate the faces in subsequent frames as the approaches may be complementary. For instance, the method proposed in the U.S. patent application 63/447,697 may compress key frames at a very low bitrate while being optimized for a desired task, the key frames may then be animated using the method presented with key points.

According to yet another implementation variant, the at least one region of a sequence of images and the background of at least one region of the sequence of images are coded using spatially adaptive quantization for adjusting the quality level of the at least one region. Advantageously, spatially adaptive quantization, implemented in most of traditional video compression standards, may be used to adjust the desired quality level for the face region in case the user wants to keep different quality levels between the background and the corresponding faces. Besides, in other variant, a filtered version of the at least one region of a sequence of images is coded for adjusting a level of details and a bitrate. For instance, some pre-filtering may be applied on face regions prior to encoding the video frame, such that the decoded faces with the low-quality branch 603 corresponds to the desired level of details vs. bitrate.

According to a second embodiment, the task-adaptive branch and the background are processed separately and then combined to reconstruct the entire frames. FIG. 5 illustrates a workflow of a novel human-centric video coding solution according to the second embodiment for instance further described in the U.S. patent application 63/447,697.

According to a first variant of the second embodiment, the bitstream comprises a low-quality representation

$${Y}_{j , la}^{i}$$

of at least one region of a sequence of images including coded data using a video compression standard and the bitstream further comprises coded data representative of a background of at least one region of the sequence of images using a video compression standard. Thus, a traditional codec may be used to encode data for background and the task-adaptive branch but into separated coded bitstream. In this case, two instances of a traditional codec can be used to process the background and the low-quality branch separately. Advantageously, this implementation is compatible with existing or future video compression standards. For instance, the main bitstream would include the background, i.e., the content within the boxes of the detected faces is either removed or blurred or adaptive quantization can be used to limit the bitrate of the unused content, and an SEI message providing information of the locations and sizes of those boxes may be used. Such SEI messages indicating regions of interest already exist in state-of-the art compression standards. Therefore, in a variant, bitstream further comprises metadata (ROI) with an indication specifying horizontal and vertical coordinates of top left corner of the at least one region and an indication specifying horizontal and vertical size of the at least one region. Then, different instances of the codec can be used to encode the low-quality branch of each face, coupled with the proposed SEI message above which contain the information related to the generative branches. The skilled in the art will appreciate that in that case, the information relative to the position of the boxes in the actual video frame is not relevant since that instance only compresses the face box. Accordingly, metadata specifying at least one generic codebook-based representation of a generic feature of at least one region of the sequence of images may comprises:
an indication specifying the number of regions to be processed by generative branches set;
an indication specifying the number of generative branches to be processed by generative branches set;
an indication identifying a generative branch to apply to the at least one region;
an indication specifying the weight that is used to merge the result of the j^{th} branch with the other branches;
an indication specifying a number of codeword indices to code the generic feature;
an indication values of codebook indices used to reconstruct the face according to the reconstruction process of the j^{th} branch.
   The exemplary syntax table described for the first embodiment will be easily adapted by the skilled in the art.

According to a second variant of the second embodiment, the bitstream comprises the low-quality representation

$${Y}_{j , lq}^{i}$$

of at least one region of a sequence of images with coded data using a normative generative compression standard and the bitstream further comprises coded data representative of a background of at least one region of the sequence of images using a video compression standard. In that variant, a brand-new codec is used for the task-adaptive branch, i.e a completely new standard including the proposed framework. The low-quality representation

$${Y}_{j , lq}^{i}$$

may be called the low-quality latent representation

$${Y}_{j , lq}^{i}$$

of at least one region of a sequence of images as in the U.S. patent application 63/447,697. The generative branches may become normative decoding processes.

In a variant, metadata specifying at least one generic codebook-based representation

$${Y}_{j , gc}^{i}$$

of a generic feature

$${Y}_{j , g}^{i}$$

of at least one region of the sequence of images are losslessly coded using arithmetic coding. Indeed, the codeword indices, instead of being parsed one by one as in the previous embodiments, are further losslessly compressed using, for instance, arithmetic coding.

In another variant, a filtered version of the background of at least one region of the sequence of images is coded. For instance, the insertion of the face regions back with the background involves filtering the borders to erase the potential block artifacts that may arise from the different compression methods used on the different regions. In yet other variant, deblocking filters from existing traditional codecs may be used.

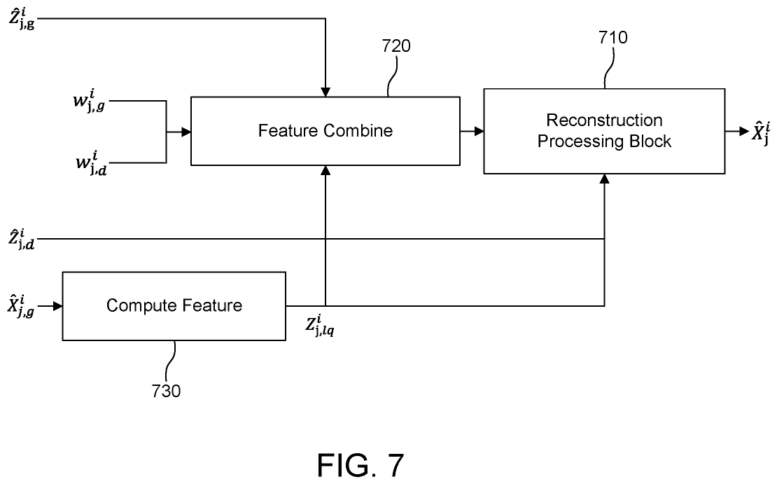

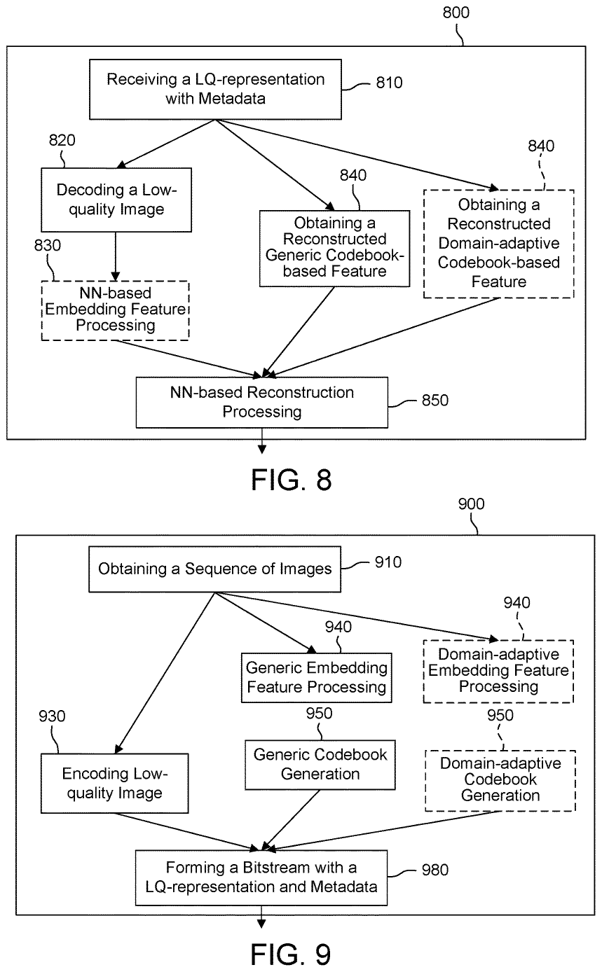

FIG. 8 illustrates a block diagram of a decoding method 800 according to one generic embodiment. In a step 810, a bitstream is received that comprises a low-quality representation of at least one region of a sequence of images along with metadata specifying at least one generic codebook-based representation of a generic feature of at least one region of the sequence of images. In a step 820, the low-quality representation

$${Y}_{j , lq}^{i}$$

is decoded and a reconstructed low-quality image

$${\hat{X}}_{j , lq}^{i}$$

is obtained. Optionally, in a step 1030, the reconstructed low-quality image

$${\hat{X}}_{j , lq}^{i}$$

is fed to a neural network-based embedding feature processor to generate a low-quality feature

$$( {Z}_{j , lq}^{i} of size {h}_{jlq}^{i} \times {w}_{jlq}^{i} \times {k}_{lq} )$$

representative of a feature of image data. Advantageously, the received metadata specifying the at least one generic codebook-based representation allows reconstructing, by a generative branch 840, a generic feature adapted to a plurality of computer vision tasks. For instance, at least one instance of the step 1040 allows to generate a reconstructed generic codebook-based feature

$$( {\hat{Z}}_{j , g}^{I} of size {h}_{j g}^{i} \times {w}_{j g}^{i} \times {k}_{g} )$$

representative of image data from the generic codebook-based representation

$${Y}_{j , gc}^{i}$$

using the metadata. In a step 850, the decoding of the bitstream, for instance based on a NN-based reconstruction processing, may combine a reconstructed generic codebook-based feature with a reconstructed low-quality image to generate a reconstructed image. Advantageously, the reconstructed image is adapted to a plurality of computer vision tasks including both machine consumption and human consumption.

FIG. 9 illustrates a block diagram of an encoding method 900 according to one embodiment. In a step 910, a sequence of images [symbol] to encode is received. In a step 930, the sequence of images [symbol] is encoded to obtain a low-quality representation

$$( {Y}_{j , lq}^{i} )$$

using any known encoding such as traditional codec HEVC/VVC or NN based LIC. For instance, in at least one instance of the step 940, a neural network-based generic embedding feature processing is applied to sequence of images to generate a generic feature [symbol] representative of a generic feature of image data samples. In a step 950, the generic feature [symbol] is encoded using a generic codebook into a generic codebook-based representation

$${Y}_{j , gc}^{i}$$

of the sequence of images, thus achieving a high compression rate. Then in a step 980, the low-quality representation

$${Y}_{j , lq}^{i}$$

is associated with metadata representative of the at least one generic codebook-based representation

$${Y}_{j , qc}^{i}$$

to form a bitstream. adapted to a plurality of computer vision tasks including both machine consumption and human consumption. Advantageously, the generated metadata specifying the at least one generic codebook-based representation will allow reconstructing, at a decoder by a generative branch, at least one generic feature adapted to a plurality of computer vision tasks. In a variant, combining weights associated with the at least one generative codebook-based representations and combining weights associated with the low-quality representation are further determined and encoded as metadata for the discriminating reconstruction processing.

We describe a number of embodiments. Features of these embodiments can be provided alone or in any combination, across various claim categories and types. Further, embodiments can include one or more of the following features, devices, or aspects, alone or in any combination, across various claim categories and types as described below.

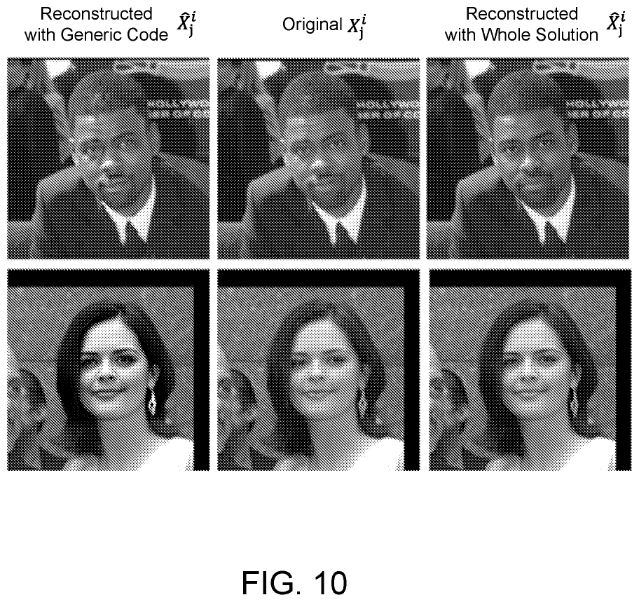

FIG. 10 shows two examples of an original and reconstructed image according to at least one embodiment. Because the learned high-quality codebook contains learned high-quality face priors, the reconstructed face can be even more visually pleasing than the original input as shown, for instance, in the bottom left photo of FIG. 10. Advantageously, the present aspects provide flexibility of task-adaptive control to accommodate various tasks' needs at the test time, scalable domain-adaptive and task-adaptive compression, a flexible framework of adopting various network architectures for individual network module components, a flexibility to accommodate various Encoding/Decoding methods in the adaptive branch, including both NN-based or traditional codecs

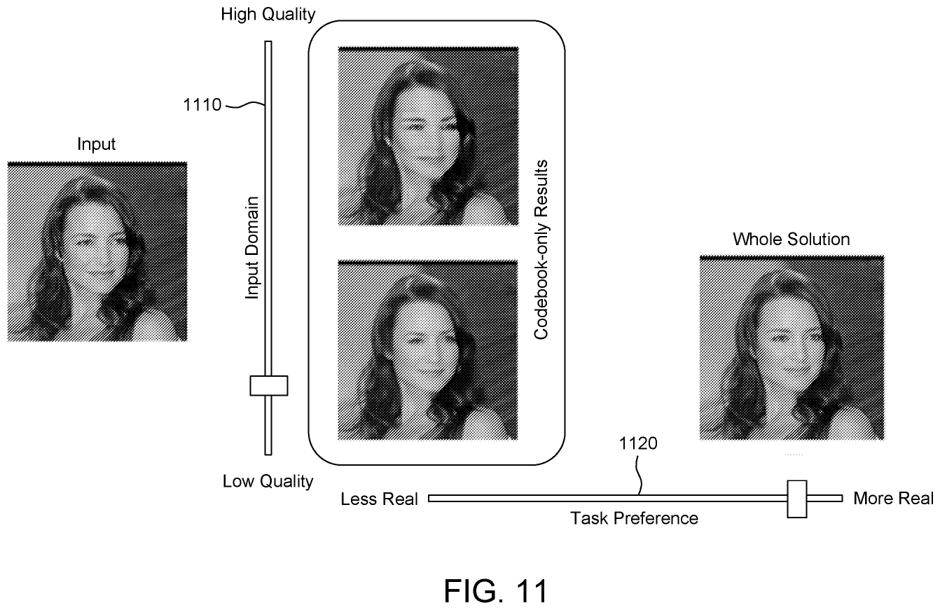

FIG. 11 shows an example of application to which aspects of the present embodiments may be applied. Human-centric video compression is essentially important in many applications, including applications for human consumption like video conferencing and applications for machine consumption like face recognition. Human-centric video compression has been one key focus in companies involving in cloud services and end devices. According to the application presented on FIG. 11, a device captures a face region and compresses it using at least one of the described embodiments. For example, a captured real input image can be shown in the sender's display device. Any type of quality controllable interface can control over some extent of bits to be used to code face or some extent of reality of to-be-delivered face at the receiver device. Quality controlling mechanism can vary. As a simple example, FIG. 11 shows a use case where a user can control along two dimensions over the quality of to-be-displayed face at the receiver's display device using human-interface panel on the device. The first dimension 1110 allows the user to control the degree the input/output face fits into the HQ generic codebook or the domain-adaptive codebook for the current domain. When the input face is not high-quality, generic codebook may generate unpleasant artifacts, which can be corrected by the domain-adaptive codebook. However, if the quality of the input face is too bad, the domain-adaptive codebook may be unreliable, and the HQ generic codebook can ensure basic reconstruction quality. This first dimension of control allows the user to tune reconstruction based on the quality of the current capture device. The second dimension 1120 allows the user to control how the low-quality input is compressed to balance bitrate, visual perceptual quality, and task performance. Generally, the less real the face, the fewer bits needed when using the proposed compression method from the task-adaptive branch. More bits are needed vice versa. The second dimension enables the user to control how real the output is according to the current task needs. According to at least one further embodiment of the present aspects, the user can also choose to use just generic codebook-based representation and domain-adaptive codebook-based representation to generate the output without the task-adaptive branch, and only tune the first dimension 1110 of control. This scenario is marked as the Codebook-Only Results.

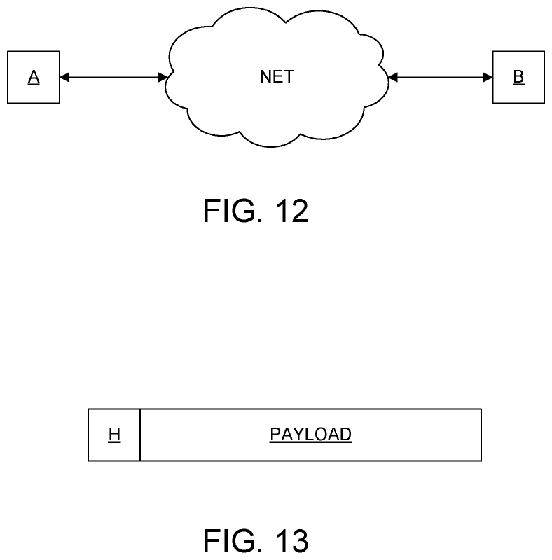

FIG. 12 shows two remote devices communicating over a communication network in accordance with an example of present principles in which various aspects of the embodiments may be implemented. According to an example of the present principles, illustrated in FIG. 12, in a transmission context between two remote devices A and B over a communication network NET, the device A comprises a processor in relation with memory RAM and ROM which are configured to implement any one of the embodiments of the method for encoding as described in relation with the FIG. 2, 4, 5, 6 or 9 and the device B comprises a processor in relation with memory RAM and ROM which are configured to implement any one of the embodiments of the method for decoding as described in relation with FIG. 3, 4, 5, 6 or 8. In accordance with an example, the network is a broadcast network, adapted to broadcast/transmit encoded images from device A to decoding devices including the device B. A signal, intended to be transmitted by the device A, carries at least one bitstream comprising coded data representative of at least one image along with metadata allowing to apply of information on the codebook-based generative compression of any of the described embodiments.

FIG. 13 shows an example of the syntax of such a signal when the at least one coded image is transmitted over a packet-based transmission protocol. Each transmitted packet P comprises a header H and a payload PAYLOAD. The payload PAYLOAD may carry the above described bitstream including metadata relative to signaling of information on the codebook-based generative compression of any of the described embodiments. In a variant, the payload comprises neural-network based coded data representative of image data samples and associated metadata, wherein the associated metadata comprises information on the codebook-based generative compression of any of the described embodiments.

It should be noted that our methods are not limited to a specific neural network architecture. Instead, our methods can be used in other neural network architectures, for example, fully factorized neural image/video model, implicit neural image/video compression model, recurrent network based neural image/video compression model or Generative Model based image/video compressing methods.

Various numeric values are used in the present application. The specific values are for example purposes and the aspects described are not limited to these specific values.

Various methods are described herein, and each of the methods comprises one or more steps or actions for achieving the described method. Unless a specific order of steps or actions is required for proper operation of the method, the order and/or use of specific steps and/or actions may be modified or combined. Additionally, terms such as “first”, “second”, etc. may be used in various embodiments to modify an element, component, step, operation, etc., such as, for example, a “first decoding” and a “second decoding”. Use of such terms does not imply an ordering to the modified operations unless specifically required. So, in this example, the first decoding need not be performed before the second decoding, and may occur, for example, before, during, or in an overlapping time period with the second decoding.

Various implementations involve decoding. “Decoding,” as used in this application, may encompass all or part of the processes performed, for example, on a received encoded sequence in order to produce a final output suitable for display. In various embodiments, such processes include one or more of the processes typically performed by a decoder, for example, entropy decoding, inverse quantization, and inverse transformation. Whether the phrase “decoding process” is intended to refer specifically to a subset of operations or generally to the broader decoding process will be clear based on the context of the specific descriptions and is believed to be well understood by those skilled in the art.

Various implementations involve encoding. In an analogous way to the above discussion about “decoding”, “encoding” as used in this application may encompass all or part of the processes performed, for example, on an input video sequence in order to produce an encoded bitstream.

The implementations and aspects described herein may be implemented in, for example, a method or a process, an apparatus, a software program, a data stream, or a signal. Even if only discussed in the context of a single form of implementation (for example, discussed only as a method), the implementation of features discussed may also be implemented in other forms (for example, an apparatus or program). An apparatus may be implemented in, for example, appropriate hardware, software, and firmware. The methods may be implemented in, for example, an apparatus, for example, a processor, which refers to processing devices in general, including, for example, a computer, a microprocessor, an integrated circuit, or a programmable logic device. Processors also include communication devices, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this application are not necessarily all referring to the same embodiment.

Additionally, this application may refer to “determining” various pieces of information. Determining the information may include one or more of, for example, estimating the information, calculating the information, predicting the information, or retrieving the information from memory.

Further, this application may refer to “accessing” various pieces of information. Accessing the information may include one or more of, for example, receiving the information, retrieving the information (for example, from memory), storing the information, moving the information, copying the information, calculating the information, determining the information, predicting the information, or estimating the information.

Additionally, this application may refer to “receiving” various pieces of information. Receiving is, as with “accessing”, intended to be a broad term. Receiving the information may include one or more of, for example, accessing the information, or retrieving the information (for example, from memory). Further, “receiving” is typically involved, in one way or another, during operations, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as is clear to one of ordinary skill in this and related arts, for as many items as are listed.

As will be evident to one of ordinary skill in the art, implementations may produce a variety of signals formatted to carry information that may be, for example, stored or transmitted. The information may include, for example, instructions for performing a method, or data produced by one of the described implementations. For example, a signal may be formatted to carry the bitstream of a described embodiment. Such a signal may be formatted, for example, as an electromagnetic wave (for example, using a radio frequency portion of spectrum) or as a baseband signal. The formatting may include, for example, encoding a data stream and modulating a carrier with the encoded data stream. The information that the signal carries may be, for example, analog or digital information. The signal may be transmitted over a variety of different wired or wireless links, as is known. The signal may be stored on a processor-readable medium.

1. A method, comprising receiving a bitstream comprising a low-quality representation of at least one region of a sequence of images along with metadata specifying at least one generic codebook-based representation of a generic feature of at least one region of the sequence of images, wherein the images are human-centric images and the at least one region is a face region, wherein the at least one generic codebook-based representation allows determining, by a generative branch, a generic feature adapted to a plurality of computer vision tasks; and
decoding, from the bitstream, a reconstructed image adapted to a plurality of computer vision tasks including both machine consumption and human consumption.

2. (canceled)

3. The method of claim 1, wherein the low-quality representation of at least one region of a sequence of images comprises coded data including the at least one region and a background of the at least one region of the sequence of images using a video compression standard.

4. The method of claim 3, wherein the metadata specifying at least one generic codebook-based representation of a generic feature of at least one region of the sequence of images are signaled as a supplemental information message.

5. The method of claim 4, wherein the metadata specifying at least one generic codebook-based representation of a generic feature of at least one region of the sequence of images are signaled with an image of the sequence of images containing faces.

6. The method of claim 3, wherein the metadata specifying at least one generic codebook-based representation of a generic feature of at least one region of the sequence of images comprises at least one of:
an indication specifying a number of regions to be processed by a set of generative branches;
an indication specifying a number of generative branches to be processed by the set of generative branches;
an indication specifying horizontal and vertical coordinates of a top left corner of the at least one region;
an indication specifying a horizontal size and a vertical size of the at least one region;
an indication identifying a generative branch to apply to the at least one region;
an indication specifying a weight that is used to merge a result of a j^{th} generative branch with results of other generative branches;
an indication specifying a number of codeword indices to code the generic feature; and
an indication of values of codebook indices used to reconstruct the face region according to a reconstruction process of the j^{th} generative branch.

7-8. (canceled)

9. The method of claim 12, wherein the low-quality representation of at least one region of a sequence of images comprises coded data using a video compression standard, and wherein the bitstream further comprises coded data representative of a background of at least one region of the sequence of images using a video compression standard.

10. (canceled)

11. The method of claim 9, wherein the metadata specifying at least one generic codebook-based representation of a generic feature of at least one region of the sequence of images comprises at least one of:
an indication specifying a number of regions to be processed by a set of generative branches;
an indication specifying a number of generative branches to be processed by the set of generative branches;
an indication identifying a generative branch to apply to the at least one region;
an indication specifying a weight that is used to merge a result of a j^{th} branch with results of other branches;
an indication specifying a number of codeword indices to code the generic feature; and
an indication of values of codebook indices used to reconstruct the face region according to a reconstruction process of the j^{th} branch.

12. The method of claim 1, wherein the low-quality representation of at least one region of a sequence of images comprises coded data using a normative generative compression standard and wherein the bitstream further comprises coded data representative of a background of at least one region of the sequence of images using a video compression standard.

13-15. (canceled)

16. A method, comprising:
obtaining a sequence of images to encode;
generating a low-quality representation of at least one region of a sequence of images along with metadata specifying at least one generic codebook-based representation of a generic feature of at least one region of the sequence of images, wherein the images are human-centric images and the at least one region is a face region, wherein the at least one generic codebook-based representation allows determining, by a generative branch, a generic feature adapted to a plurality of computer vision tasks; and
encoding, in a bitstream, a low-quality representation of at least one region of a sequence of images along with metadata specifying at least one generic codebook-based representation of a generic feature of at least one region of the sequence of images.

17. (canceled)

18. The method of claim 16 wherein the low-quality representation of at least one region of a sequence of images comprises coded data including the at least one region and a background of the at least one region of the sequence of images using a video compression standard.

19. The method of claim 18, wherein the metadata specifying at least one generic codebook-based representation of a generic feature of at least one region of the sequence of images are signaled as a supplemental information message.

20. The method of claim 19, wherein the metadata specifying at least one generic codebook-based representation of a generic feature of at least one region of the sequence of images are signaled with an image of the sequence of images containing faces.

21. The method of claim 18, wherein metadata specifying at least one generic codebook-based representation of a generic feature of at least one region of the sequence of images comprises at least one of:
an indication specifying a number of regions to be processed by a set of generative branches;
an indication specifying a number of generative branches to be processed by the set of generative branches;
an indication specifying horizontal and vertical coordinates of a top left corner of the at least one region;
an indication specifying a horizontal size and a vertical size of the at least one region;
an indication identifying a generative branch to apply to the at least one region;
an indication specifying a weight that is used to merge a result of a j^{th} generative branch with results of other generative branches;
an indication specifying a number of codeword indices to code the generic feature; and
an indication of values of codebook indices used to reconstruct the face region according to a reconstruction process of the j^{th} generative branch.

22-23. (canceled)

24. The method of claim 16, wherein the low-quality representation of at least one region of a sequence of images comprises coded data using a video compression standard, and wherein the bitstream further comprises coded data representative of a background of at least one region of the sequence of images using a video compression standard.

25. (canceled)

26. The method of claim 24, wherein the metadata specifying at least one generic codebook-based representation of a generic feature of at least one region of the sequence of images comprises at least one of:
an indication specifying a number of regions to be processed by a set of generative branches;
an indication specifying a number of generative branches to be processed by the set of generative branches;
an indication identifying a generative branch to apply to the at least one region;
an indication specifying a weight that is used to merge a result of a j^{th} branch with results of other branches;
an indication specifying a number of codeword indices to code the generic feature; and
an indication of values of codebook indices used to reconstruct the face region according to a reconstruction process of the j^{th} branch.

27. The method of claim 16, wherein the low-quality representation of at least one region of a sequence of images comprises coded data using a normative generative compression standard and wherein the bitstream further comprises coded data representative of a background of at least one region of the sequence of images using a video compression standard.

28-32. (canceled)

33. An apparatus comprising a memory and one or more processors, wherein the one or more processors are configured to:
receive a bitstream comprising a low-quality representation of at least one region of a sequence of images along with metadata specifying at least one generic codebook-based representation of a generic feature of at least one region of the sequence of images, wherein the images are human-centric images and the at least one region is a face region, wherein the at least one generic codebook-based representation allows determining, by a generative branch, a generic feature adapted to a plurality of computer vision tasks; and
decode, from the bitstream, a reconstructed image adapted to a plurality of computer vision tasks including both machine consumption and human consumption.

34. (canceled)

35. The apparatus of claim 33, wherein the low-quality representation of at least one region of a sequence of images comprises coded data including the at least one region and a background of the at least one region of the sequence of images using a video compression standard.

36. An apparatus comprising a memory and one or more processors, wherein the one or more processors are configured to:
obtain a sequence of images to encode;
generate a low-quality representation of at least one region of a sequence of images along with metadata specifying at least one generic codebook-based representation of a generic feature of at least one region of the sequence of images, wherein the images are human-centric images and the at least one region is a face region, wherein the at least one generic codebook-based representation allows determining, by a generative branch, a generic feature adapted to a plurality of computer vision tasks; and
encode, in a bitstream, a low-quality representation of at least one region of a sequence of images along with metadata specifying at least one generic codebook-based representation of a generic feature of at least one region of the sequence of images.

37. (canceled)

38. The apparatus of claim 36, wherein the low-quality representation of at least one region of a sequence of images comprises coded data including the at least one region and a background of the at least one region of the sequence of images using a video compression standard.
